(19) United States
(12) Patent Application Publication
(10) Pub. No.: US 2016/0025973 A1
(43) Pub. Date: Jan. 28, 2016

(54) Compact Heads-Up Display System

(71) Applicant: Navdy, Inc., San Francisco, CA (US)

(72) Inventors: Karl M. Guttag, Round Rock, TX (US); Douglas Simpson, Berkeley, CA (US); Paul Michalczuk, Santaquin, UT (US); Jesse Madsen, Oakland, CA (US); David Baik, Sunnyvale, CA (US); Ali Rahimi, San Francisco, CA (US)

(21) Appl. No.: 14/806,530

(22) Filed: Jul. 22, 2015

Related U.S. Application Data
(60) Provisional application No. 62/027,622, filed on Jul. 22, 2014.

(51) Int. Cl. G02B 27/01; G06F 3/01

(52) U.S. Cl. CPC G02B 27/0101; G02B 27/0149; G06F 3/017; G02B 2027/013; G02B 2027/0154; G02B 2027/0161; G02B 2027/0169; G02B 2027/0138

(57) ABSTRACT

A portable heads-up display device for deployment on the dashboard of a vehicle. The device includes a housing suitable for mounting to or placing on a surface, and containing system electronics and a projector. A curved high-gain reflective screen disposed on the housing rearward of the projector receives an image produced by the projector, and reflects that image to a semi-transparent curved combiner disposed near the front of the housing. A virtual image appears at the combiner that has a focal point in the distance beyond the combiner. One or more rear-facing sensors and the control electronics detect hand gestures by the driver, which controls the operation of the device in displaying images. The device mounts to a dashboard via a conformable and foot that adapts to the shape of the dashboard. Magnetic coupling between the housing and a puck element held in the foot facilitates removal and replacement of the device.

### CROSS-REFERENCE TO RELATED APPLICATIONS

This application claims priority, under 35 U.S.C. §119(e), of Provisional Application No. 62/027,622, filed Jul. 22, 2014, and incorporated herein by this reference.

### STATEMENT REGARDING FEDERALLY SPONSORED RESEARCH OR DEVELOPMENT

Not applicable.

### BACKGROUND OF THE INVENTION

This invention is in the field of displaying a semi-transparent image to an operator of a vehicle, such an image commonly referred to as a “heads-up” display image.

The basic concept of a heads-up display (“HUD”) is to provide relevant information to the operator of an automobile, airplane, or other vehicle, in the form of an image displayed in front of the operator so that the driver (in the automobile context) can view that information without lowering his eyes or otherwise focusing away from the road ahead. Typically, a heads-up display is semi-transparent so that the road can largely be seen through the displayed image.

Conventional automotive HUD devices and systems have a relatively large form factor. For example, the optics and electronics of conventional built-in HUD systems occupy a volume of on the order of 2 liters within the automobile dash. These large physical volumes have limited the success of conventional after-market HUD systems. Other limitations of conventional after-market HUD include their poor readability in sunlight conditions, limited display capability, and processing capability and flexibility.

### BRIEF SUMMARY OF THE INVENTION

Disclosed embodiments provide a compact portable heads-up display (“HUD”) system that is suitable for placement on top of the dash of most modern automobiles while not obstructing the forward view of the operator.

Disclosed embodiments provide such a system in which the displayed image is largely transparent under conditions ranging from full sunlight, including when the vehicle is pointing in the direction of the sun, to nighttime.

Disclosed embodiments provide such a system that can operate as a full processing and computing system capable of autonomous operation, for example operating on data received from networked computing devices, such as a nearby smartphone, for example by navigating to a destination address communicated from a networked device.

Disclosed embodiments provide such a system in which the elements for displaying the images can be readily adjusted with minimal distortion in the image.

Disclosed embodiments provide such a system that is readily removable and mountable to a wide variety of vehicle dashboard and windshield geometries.

Disclosed embodiments provide such a system capable of visually displaying information from a networked device or another system, and filtering that information according to existing conditions (e.g., vehicle speed).

Disclosed embodiments provide such a system that can include one or more auxiliary input and output devices, including one or more sensors for detecting operator gestures; audio input and output; wireless communication; environmental, motion, and positional sensors; and the like, and that can operate on inputs received from such devices.

Disclosed embodiments provide such a system that consume very low levels of power by efficiently using the projected light, minimizing battery usage and also enabling compact construction and low manufacturing cost.

Other objects and advantages of the disclosed embodiments will be apparent to those of ordinary skill in the art having reference to the following specification together with its drawings.

Embodiments of the invention may be implemented in a heads-up display device including a housing suitable for mounting to or placing on a surface, and containing system electronics and a projector. A curved high-gain reflective screen disposed on the housing rearward of the projector receives an image produced by the projector, and reflects that image to a semi-transparent curved combiner disposed near the front of the housing.

According to another aspect, embodiments of the invention may be implemented in a heads-up display device including a housing for a projector controlled by system electronics in the housing, an attached screen receiving images projected by the projector, and an infrared illuminant and a camera sensitive to infrared light, both integrally mounted in the device to be pointed in the direction toward an operator viewing the projected images. The camera is coupled to the system electronics, which include processing capability for recognizing gestures made by the operator. The infrared operation of the camera permits the display device to be controlled by gestures in minimal ambient light conditions.

According to another aspect, embodiments of the invention may be implemented in a heads-up display device including a housing and semi-transparent viewing screen, in combination with a “foot” coupled to the bottom of the housing and adaptable to vehicle dashboards, and a puck that magnetically couples to a magnet in the housing and which provides electrical connection to control electronics in the housing. The foot has a stiffener with an opening for receiving the puck, and a bendable portion extending from the stiffener that conforms and can adhere to a wide range of vehicle dashboards. The bendable portion includes a core that is of a material, such as an aluminum alloy, that retains its bent shape. A conformable material of some stickiness is attached to the bottomside of the bendable plate, so that the device will remain at the dash location when placed. Separation of the housing with the electronics and optical components is facilitated by the magnetic coupling with the puck disposed within the foot.

### BRIEF DESCRIPTION OF THE SEVERAL VIEWS OF THE DRAWING

FIG. 1 is a perspective view illustrating an automotive application of a heads-up display (HUD) device according to embodiments.

FIGS. 2a and 2b are side and rear cross-sectional views, respectively, of an HUD device constructed according to an embodiment.

FIG. 2c is a side elevation and functional view of a HUD system incorporating the device of FIGS. 2a and 2b according to an embodiment.

FIG. 3a is a side cross-sectional view of a HUD device according to an embodiment, illustrating light paths in its operation.

FIG. 3b is a top play view of the HUD device of FIG. 3a, illustrating light paths and image formation in its operation.

FIGS. 4a through 4c are top plan schematic views and associated plots of reflected light intensity, comparing that of a screen according to an embodiment with conventional flat screen surfaces.

FIG. 4d is a cross-sectional view of a screen in an HUD device of an embodiment, illustrating its optical gain characteristics relative to conventional reflective surfaces.

FIGS. 4e through 4g are side cross-sectional views of screens according to alternative respective embodiments.

FIG. 5a is a cross-sectional view of a combiner in an HUD device of an embodiment.

FIGS. 5b and 5c are cross-sectional and elevation views, respectively, of a multiple range combiner according to another embodiment.

FIGS. 6a and 6b are side elevation views of an HUD device at different angular positions of the screen and combiner, according to an embodiment.

FIG. 7 is an electrical diagram, in block form, of the architecture of control electronics in the HUD device of an embodiment.

FIG. 8 is a flow diagram illustrating the operation of an HUD device according to an embodiment in response to gestures, voice input, and incoming communications according to an embodiment.

FIGS. 9a and 9b are flow diagrams illustrating examples of the operation of an HUD device according to the embodiment of FIG. 8.

FIG. 10 is an exploded perspective view of the major physical components of an HUD device according to an embodiment.

FIG. 11 is an exploded perspective view of the housing of an HUD device according to an embodiment.

FIGS. 12a and 12b are plan and cross-sectional views, respectively, illustrating the mating of the housing of FIG. 11 with a puck according to an embodiment.

FIGS. 13a through 13f are plan and elevation views of the mounting of an HUD device onto a foot of various embodiments.

### DETAILED DESCRIPTION OF THE INVENTION

The one or more embodiments described in this specification are implemented into a heads-up display (HUD) device and system as used by a driver of an automobile, as it is contemplated that such implementation is particularly advantageous in that context. However, it is also contemplated that concepts of this invention may be beneficially applied to in other applications, for example aviation and marine applications, as well as other applications including but not limited to video games, advertising displays, amusement park displays, simulation systems, and other applications where a transparent display may be useful. Accordingly, it is to be understood that the following description is provided by way of example only, and is not intended to limit the true scope of this invention as claimed.

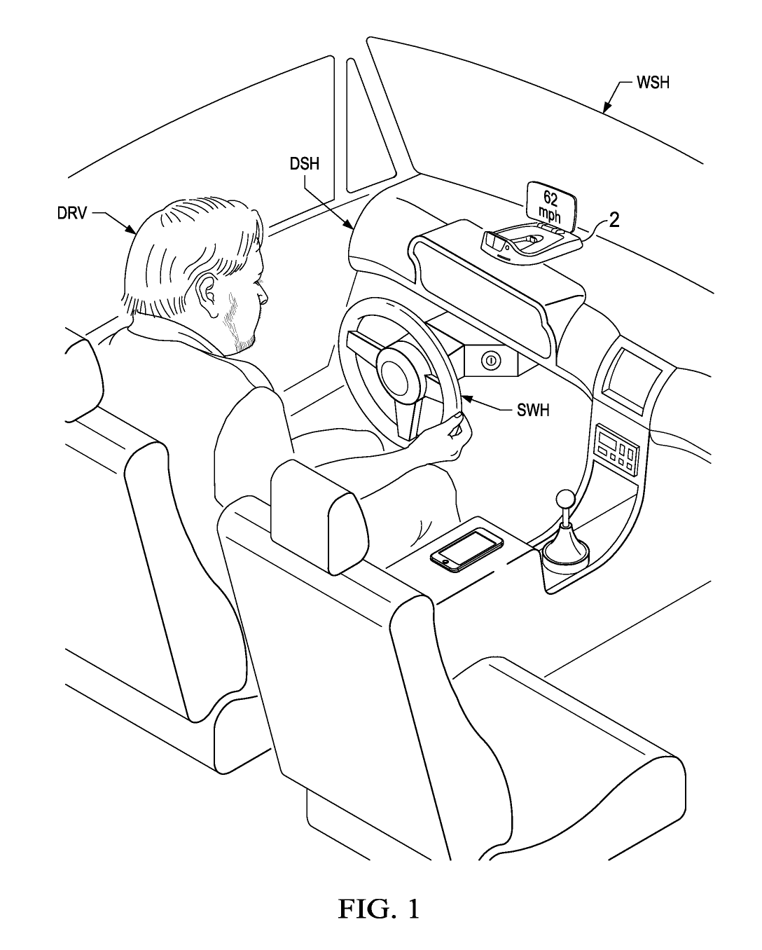

As will be apparent from this description and as noted above, the embodiments of the invention described herein relate to a see-through display device commonly known as a “heads-up display” or “HUD”. FIG. 1 illustrates the general application of devices according to these embodiments in an automotive context. As shown in FIG. 1, HUD device 2 in this context sits on top of car dashboard DSH, typically in view by driver DRV above the speedometer and other gauges or operational displays (not shown) provided within dashboard DSH, and above steering wheel SWH. HUD device 2 provides a see-though image that displays information relevant to driver DRV while driving the vehicle, without blocking the view of the road through windshield WSH.

As will be evident from the following description, HUD device 2 according to this embodiment is constructed so as to be portable, easily placed atop dashboard DSH of a variety of vehicles, and easily removable for use in another vehicle or for security purposes, such as when driver DRV is parking the car in a public parking area. As such, in these embodiments HUD device 2 is constructed to have a compact size so that it can sit on top of dashboard DSH, without significantly interfering with the driver's view.

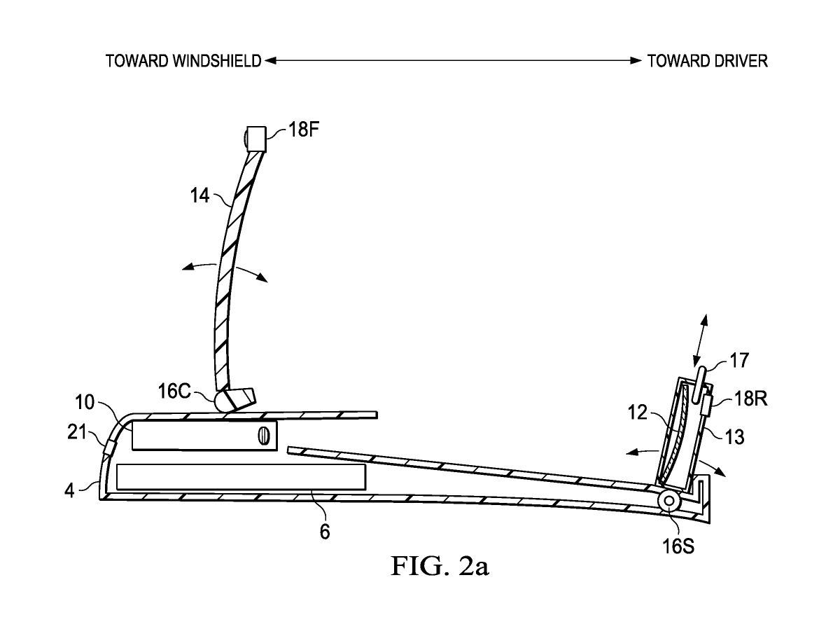

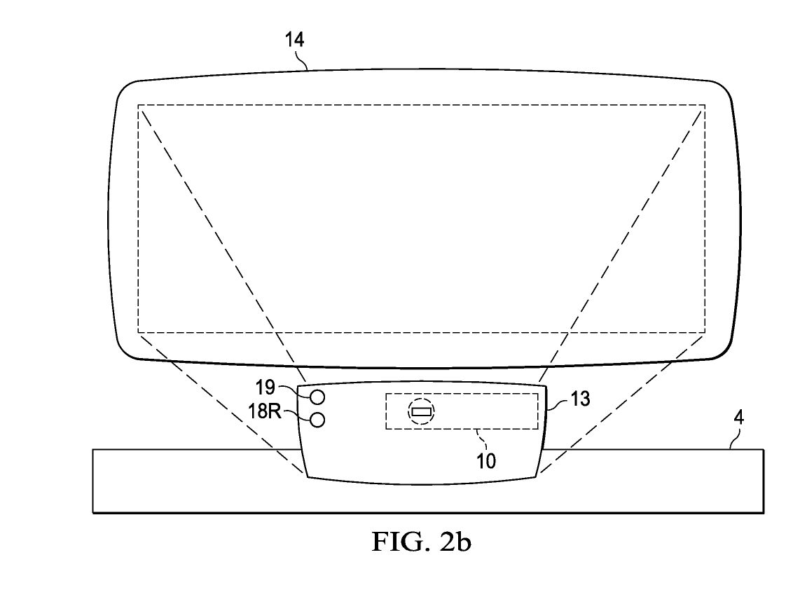

The cross-sectional view of FIG. 2a schematically illustrates the various components of HUD device 2 according to some embodiments. As shown in that Figure, housing 4 encloses control electronics 6, for example as may be mounted on one or more printed circuit boards, and which carry out the data and image processing involved in the operation of HUD device 2 as will be described below. The architecture and functionality of control electronics 6 according to some embodiments will be described in detail below.

Housing 4 also encloses projector engine 10 which, for purposes of this description, refers to a projection system, including the optics, light modulation, and light source devices necessary to project an image suitable for use in HUD device 2 according to these embodiments. The optics included in projector engine 10 are contemplated to include some or all of the appropriate lenses, mirrors, light homogenization devices, polarization devices, filters such as dichroic filters that combine light, and such other optical devices known in the art and included in the construction of a modern projector. Light modulation devices included in projector engine 10 may be any one of a number of types, including those known in the art as digital micromirror array devices (DMD) such as the DLP™ device from Texas Instruments, liquid crystal on silicon (LCOS) light modulators, and transmissive LCD displays such as those used in LCD projectors or other type of spatial light modulator; other types of light modulation device suitable for use in some embodiments include a laser beam scanning (LBS) projector, in which a laser light source is modulated electronically or otherwise and the laser beam is scanned by one or more moving mirrors to scan the image, and any other form of image projection. The light source included in projector engine 10 may be one or more LEDs, one or more lasers, or other sources of light. For example, red, green, and blue LEDs or lasers are commonly used with DMD and LCOS modulators, to support what is known as a “full color” display, but of course other colors of light may additionally or alternatively be used. In any of these technologies, projector engine 10 is contemplated to also include the appropriate electronics for controlling these elements, as known in the art.

Projector engine 10 projects images rearwardly (i.e., toward driver DRV) to curved screen 12 within screen enclosure 13 mounted near the rear edge of housing 4 in this embodiment. As will be described in detail below, screen 12 is a reflective surface, for example a high-gain curved reflective surface, positioned relative to projector engine 10 so that the light projected by projector engine 10 forms a “real” image on screen 12. The construction of screen 12 will be described in further detail below.

According to these embodiments, screen 12 reflects this real image in a forward direction (i.e., toward the windshield) to combiner 14. Combiner 14 according to these embodiments is a semi-transparent curved element that combines light from two directions, namely that transmitted through windshield WSH and that reflected from screen 12, to form a combined “virtual” image that is viewable by driver DRV in the arrangement of FIG. 1. Combiner 14 is semi-transparent in the sense that road conditions and other visual information ahead of the vehicle (i.e., light entering through windshield WSH) can be seen by driver DRV through combiner 14, but on which the images projected by projector engine 10 and reflected by screen 12 will also be visible to driver DRV. The construction of combiner 14 will be described in further detail below.

FIG. 2b illustrates HUD device 2 from the rear, i.e. from the viewpoint of driver DRV of FIG. 1. As evident from FIG. 2b, driver DRV sees the back surface of screen enclosure 13, within which screen 12 (FIG. 2a) is disposed so as to face projector engine 10 (shown in shadow in FIG. 2b). Because of the construction and arrangement of screen 12 and combiner 14 as will be described in detail below, the image presented by the light projected by projector engine 10 forms image IMG_12 at screen 12. This image IMG_12 will reflect from screen 12 and appear on combiner 14 as image IMG_14, as shown in FIG. 2b. Image IMG_14 thus presents graphics and other visual information generated by control electronics 6 within housing 4 as appropriate for the particular functions being executed, in a manner that is visible to driver DRV. Screen enclosure 13 serves to block light emitted by projector engine 10 from directly reaching driver DRV, as evident in the view of FIG. 2b. And as discussed above and in further detail below, because combiner 14 is semi-transparent according to these embodiments, driver DRV will be able to see the road ahead through combiner 14, with image IMG_14 effectively overlaid onto that view of the road.

FIGS. 2a and 2b also illustrate various auxiliary components of HUD device 2 that may be implemented in various embodiments. Rear-facing camera 18R is mounted, in this embodiment, on the driver side of screen enclosure 13, and as such is aimed at driver DRV. As will be described in further detail below, image data acquired by rear-facing camera 18R are communicated to control electronics 6, which processes those data to identify gestures made by driver DRV and carry out various control functions responsive to those identified gestures. To enable this function in nighttime conditions, rear-facing camera 18R is sensitive to infrared light, and infrared illuminant 19 (e.g., an LED emitting infrared light) is mounted on the driver-side surface of screen enclosure 13 and also facing driver DRV. It has been discovered, according to these embodiments, that infrared illuminant 19 is preferably mounted above rear-facing camera 18R to reduce the shadowing effect of steering wheel SWH (FIG. 1) in the images captured by camera 18R. Other gesture-detection technologies may alternatively be implemented in place of or in addition to rear-facing camera 18R, examples of which include depth sensors, photometric stereo sensors, and dual camera arrangements.

In some embodiments, direct lens light block 17 is mounted at the top edge of screen enclosure 13. Direct lens light block 17 is an opaque structure that blocks light emitted by projector engine 10 from directly reaching the eyes of driver DRV, particularly in the case of a tall driver. For example, direct lens light block 17 may be constructed as an opaque plastic plate that can be adjustably slid up or down relative to the top edge of screen enclosure 13 by driver DRV, to accomplish this light-blocking function in a variety of installations.

Front-facing camera 18F may be provided in some embodiments, for example mounted to the top edge of combiner 14 and aimed in the direction of windshield WSH. In these embodiments, front-facing camera 18F communicates image data pertaining to the location of the vehicle within or among lanes of the roadway, road conditions, or other environmental parameters visible through windshield WSH to control electronics 6, which in turn generates information for display at combiner 14 in response to that information. FIG. 2a also shows ambient light sensor 21 mounted on housing 4, which will communicate the level of ambient light to control electronics 6, in some embodiments; more than one such ambient light sensor 21 may be implemented in HUD device 2 if desired. If ambient light sensor 21 is implemented, control electronics 6 can adjust the brightness and other attributes of the light projected by projector engine 10, typically to increase brightness of the displayed images under bright ambient conditions and reduce brightness at nighttime.

FIG. 2a shows combiner 14 as physically coupled to housing 4 by way of hinge 16C, and screen 12 as physically coupled to housing 4 by way of hinge 16S. Hinge 16C enables the angle of combiner 14 to be rotationally adjusted about its axis, and hinge 16S enables the angle of screen 12 to be rotationally adjusted about its axis (each of which is into and out of the page in FIG. 2a). This adjustability ensures good visibility of the image displayed to driver DRV for a variety of dashboard DSH geometries (i.e., regardless of the flatness of the top surface of dashboard DSH) and with minimal distortion of the image, as will be described in further detail below.

FIG. 2c illustrates the implementation of HUD device 2 into a communications system in combination with various functions in the automotive context, according to certain embodiments. In this example, HUD device 2 includes wireless communications functionality as part of or in conjunction with its control electronics 6, operable to carry out wireless transmission and receipt according to a conventional technology such as Bluetooth or other near-field communications (NFC) types for local communication with nearby devices (i.e., in the vehicle); longer-range communication capability such as cellular, satellite, FM and other radio communications may additionally or alternatively be implemented. In this example, the system includes smartphone SPH, which will typically be personal to driver DRV and include the appropriate software for communicating with HUD device 2. By way of this communication with smartphone SPH, HUD device 2 will be capable of displaying online-accessible information regarding traffic, weather conditions, text messages, email, and the like. The system of the embodiment shown in FIG. 2c also includes one or more rear cameras RCM, which may be deployed within the automobile, for example on the exterior rear of the vehicle, or internally to the vehicle such as on its ceiling or behind the driver's seat; communication between HUD device 2 and rear camera RCM allows HUD device 2 to display images on combiner 14 showing views from behind the vehicle or of the interior behind driver DRV, as the case may be, without requiring driver DRV to physically turn around or take her eyes off the road. Also shown in FIG. 2c, USB port 21 of HUD device 2 is provided for wired communication with on-board diagnostic port OBDP of the vehicle in which HUD device 2 is installed; by way of this connection, information regarding the operating parameters or condition of the vehicle, either directly or in combination with navigation information (distance to next filling station) can be displayed to driver DRV at combiner 14. It is contemplated that those skilled in the art having reference to this specification will be readily capable of implementing these functions, and additionally or alternatively other functions beyond those shown in this FIG. 2c, as desired, without undue experimentation.

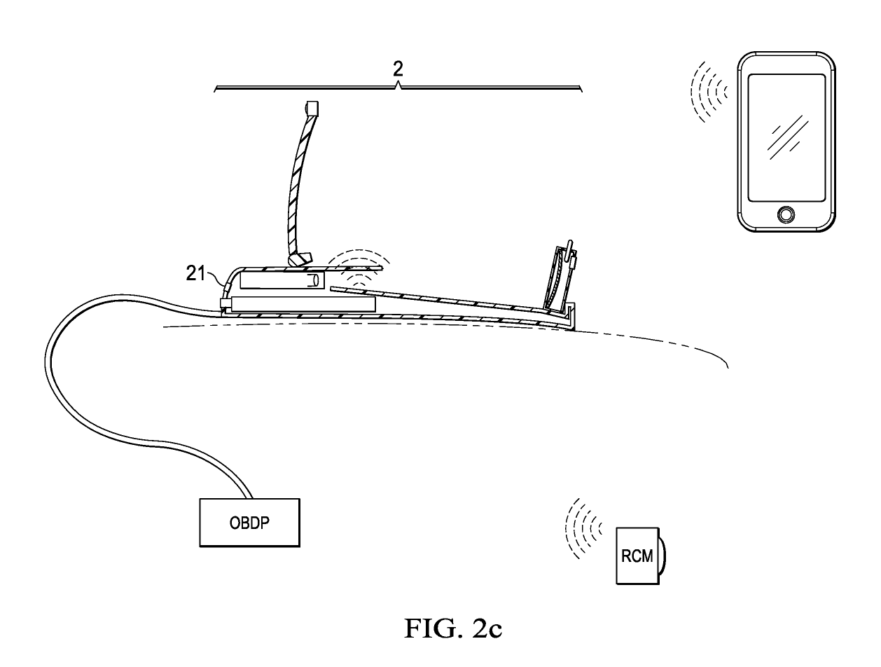

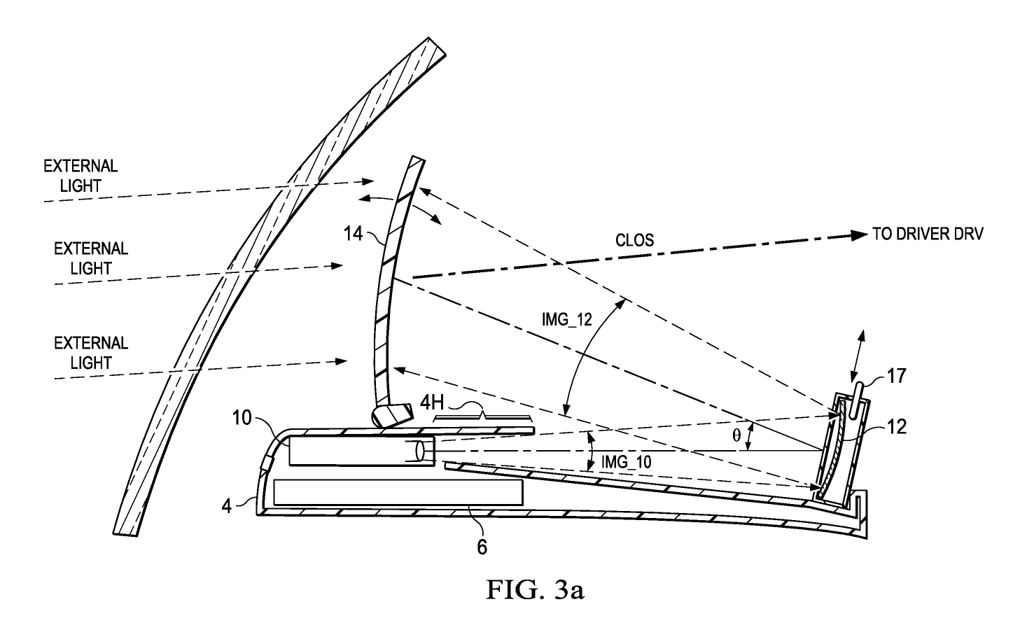

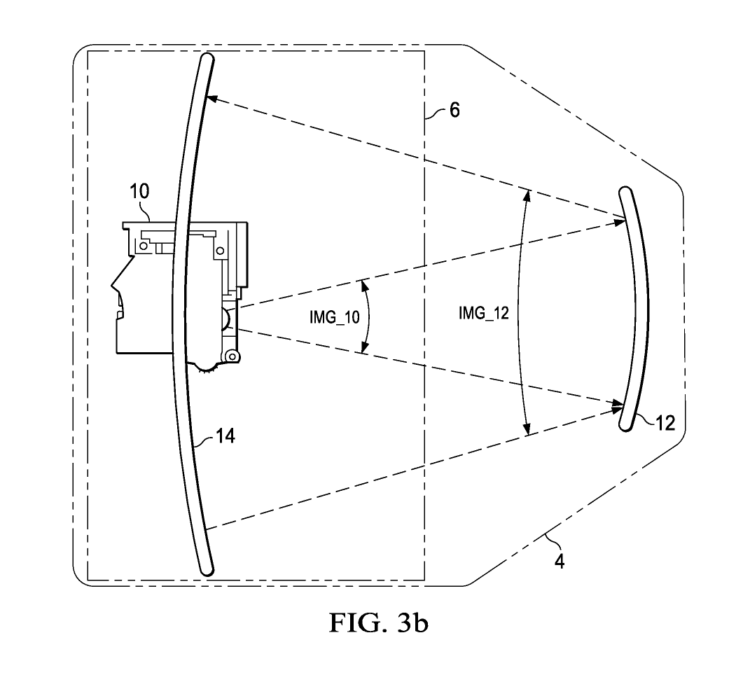

FIGS. 3a and 3b illustrate side elevation and top plan views, respectively, of the basic optical path according to some embodiments of the invention. As shown in each of FIGS. 3a and 3b, projector engine 10 projects light on image path IMG_10 toward screen 12 to form a real (human-viewable) image at screen 12. That image is reflected by screen 12 on image path IMG_12 to combiner 14, and in turn partially reflected by combiner 14 to be visible to driver DRV along a center line-of-sight CLOS. As noted above, combiner 14 is constructed to be semi-transparent to external light such as received through windshield WSH; this semi-transparency also connotes that combiner is semi-reflective to the light reflected by screen 12. These properties may be attained by coatings on the surfaces of combiner 14. For example, the surface of combiner 14 may have a 30% reflective coating, in which case 30% of the reflected light from screen 12 will be reflected toward driver DRV, while roughly 70% of the external light received through windshield WSH will be transmitted through combiner 14 to be visible to driver DRV. The particular construction of combiner 14 according to embodiments will be described in further detail below;

Because the image projected on screen 12 by projector engine 10 is a “real” image, it is useful for projector engine 10 to be constructed and arranged to project that image so as to be focused on screen 12. In this example, screen 12 is placed in the focal plane of the lens of projector engine 10. In one example in which the lens of projector engine 10 has a focal distance of about 100 mm, screen 12 is placed at distance of about 100 mm from projector engine 10. For projector engine 10 constructed as a DMD or LCOS light modulator type projector, a focus adjustment may be required at manufacture that then remains fixed in place for system use. For those projectors 10 using laser illumination, however, the depth of focus may be sufficient that no additional focusing may be required. It will also be understood by one skilled in the art that because lasers have much narrower bandwidths/linewidths at a given center frequency, the use of lasers can provide better performance with such optical elements at screen 12 such as bandpass filters.

According to some embodiments, screen 12 is constructed to have a substantially spherical curved inner surface that receives light from projector engine 10. The degree of curvature of screen 12 is selected so that the light rays reflected from its surface to combiner 14, and reflected from combiner 14, are focused at the eye pupils of driver DRV. In one example of a dashboard HUD device 2 in the automotive context, in which the eye pupil of driver DRV is nominally expected to be at about 30 inches from combiner 14, a radius of curvature of the inner surface of screen 12 of on the order of about 440 mm provides good results. In addition, as known in the art, spherical surfaces are concave surfaces that approximate a section of the surface of a sphere. The term “substantially spherical”, for purposes of this description, refers to a surface that is not perfectly spherical but is sufficiently close to being spherical so as to behave similarly to a perfectly spherical surface within the context of these embodiments. Referring to the driver's view of FIG. 2b, if the projected image from projector engine 10 is as designed for a flat screen with no projection lens offset, that image would appear at screen 12 as slightly “keystoned” (wider at the top than at the bottom) because of the tilt of screen 12, and slightly barrel distorted (smaller at the outsides of the screen than in the center) because of the curvature of screen 12. When reflected to and appearing at combiner 14, the apparent barrel distortion would be further increased by the optical effect of the curvature of combiner 14 since the outside of curved screen 12 is farther away from combiner 14 than is the center of screen 12. In some embodiments, however, screen 12 is constructed to have a “substantially spherical” surface, meaning that the surface behaves similarly to one that is perfectly spherical for purposes of embodiments of this invention, but is not perfectly spherical; specifically by being slightly aspherical so as to help correct for the keystone distortion or barrel distortion, or both, resulting from the tilt and curvature of the inner surface of screen 12.

Alternatively or in addition, these distortions may be corrected for optically by the design of the projector lens in projector engine 10, or by also making combiner 14 slightly aspherical (while remaining “substantially spherical” as defined above), or by digital processing of the image being projected to pre-distort the image so it will look correct at combiner 14 as viewed by driver DRV, or by a combination of these techniques.

According these embodiments, screen 12 is constructed to have a high screen “gain”, in the optical sense. As known in the art, screen gain is a measure of the peak brightness of light reflected in a direction normal to the screen surface. As commonly understood in the art of projection screens, screen gain is typically a relative measure, where a gain of 1.0 refers to a screen that reflects light at the same brightness at which it is projected onto the screen with perfect uniformity from all viewing angles, with no light absorbed and all light re-radiated. Gain is typically measured from the vantage point where the screen is at its brightest, which is directly in front of and perpendicular to the tangent of the screen at that point. As such, the measurement of gain at this point is known as “Peak Gain at Zero Degrees Viewing Axis”. Surfaces having a gain of 1.0 include a block of magnesium carbonate (MgCO₃) and a matte white screen. A screen having a gain above 1.0 will reflect brighter light than that projected; for example, a screen rated at a gain of 1.5 reflects 50% more light in the direction normal to the screen than a screen rated at a gain of 1.0. However, screens with a gain greater than 1.0 do not reflect light at the same brightness at all viewing angles. Rather, if one moves to the side so as to view the screen at an angle, the brightness of the projected image will drop.

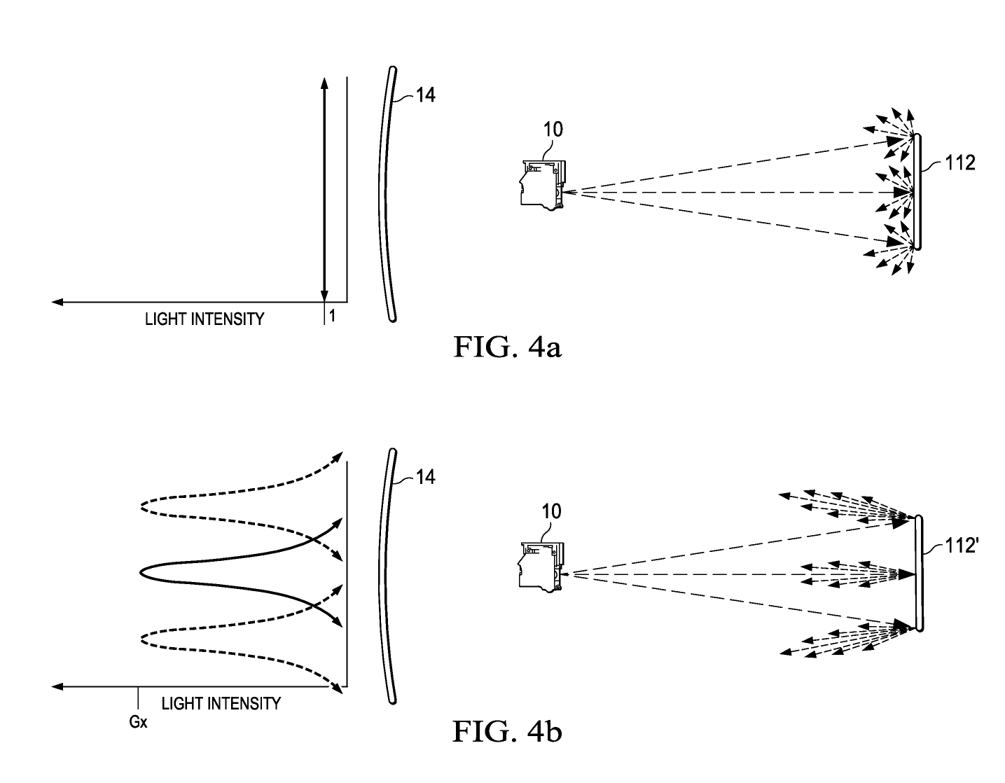

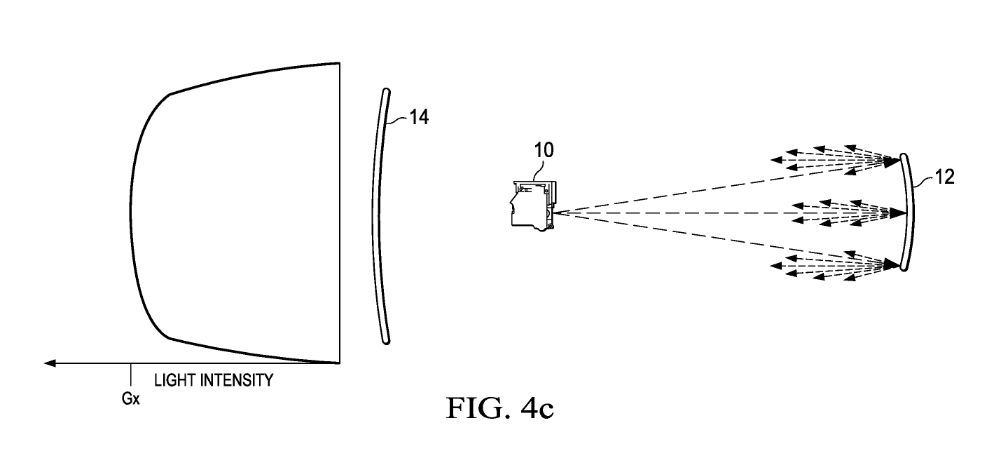

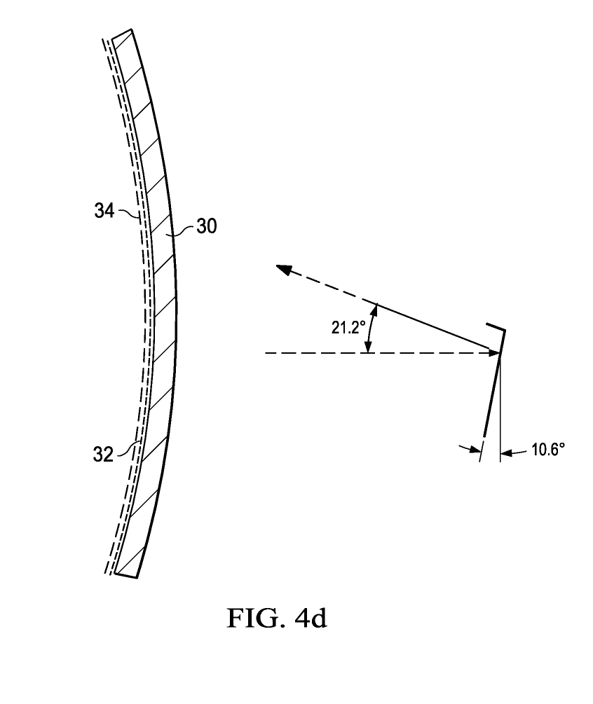

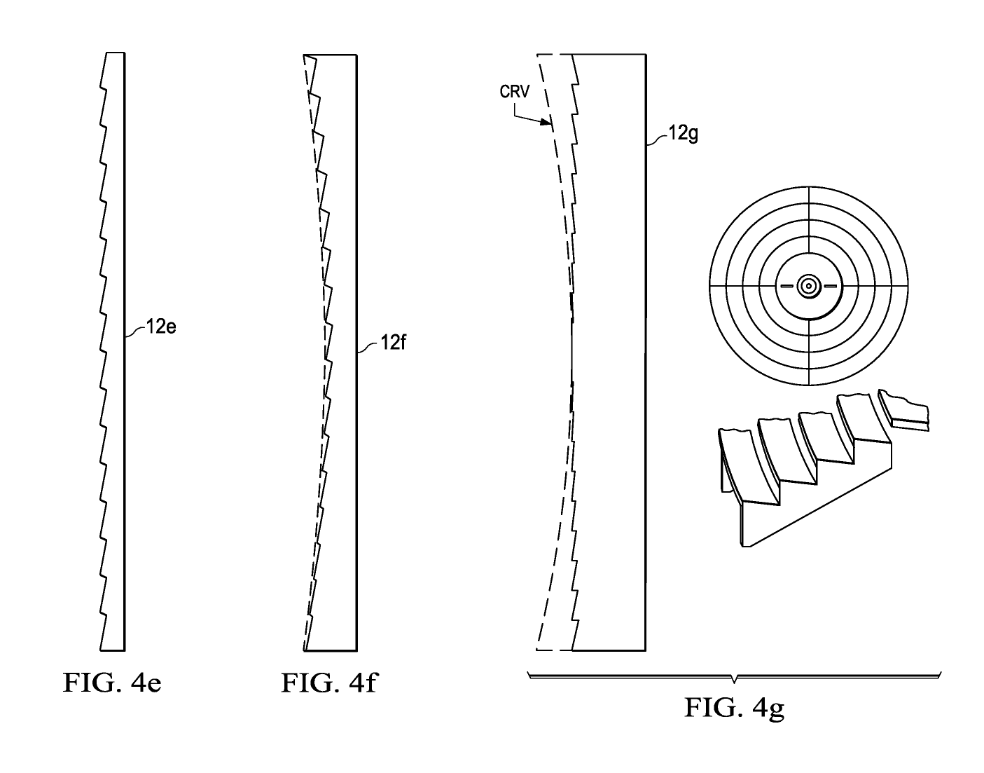

FIGS. 4a and 4b illustrate the relative reflected brightness of unity (1.0) gain and high gain flat screens, respectively, in the context of the optical arrangement of HUD device 2 in which projector engine 10 projects light onto a screen, with the light reflected from the screen directed to curved combiner 14. The views of FIGS. 4a and 4b are “top-down” views, in the same orientation as shown in FIG. 3b, showing the light patterns of light of a uniformly white image projected to the center and to two off-center points of the respective screens 112, 112′, and illustrating profiles of the light rays as reflected off the surface of the respective screens 112, 112′ to combiner 14. Screen 112 in FIG. 4a is a conventional unity gain flat screen, from which the projected light from projector engine 10 reflects uniformly in all directions from each point on screen 112, whether from the center location directly in front of projector engine 10 (i.e., at a point receiving light in the direction normal to screen 112), or at the off-center points that are at an angle from projector engine 10. Because of the unity gain and flat surface of screen 112, the reflected light is of uniform intensity (i.e., a relative intensity of 1.0) as received at all points along the surface of combiner 14, as shown by the plot on the left-hand side of FIG. 4a. However, much of the light reflected from screen 112 will miss combiner 14, considering that the reflected light is spread over 180° from the surface of screen 112 while combiner 14 covers only a fraction of that 180° spread. For the case of a uniformly white image projected by projector engine 10, the viewer of combiner 14 will see a uniformly white but dim image.

FIG. 4b illustrates the reflection characteristics of high-gain (a gain of Gₓ>1) flat screen 112′ in the same context. The light rays shown in the Figure as reflecting from screen 112′ have an amplitude of the reflected light is higher (i.e., the lengths of the rays are longer than in FIG. 4a), indicating that screen 112′ is more reflective than screen 112, but the directionality of the reflected light is much more confined to a center profile as compared with that from screen 112 of FIG. 4a. The amplitude of the reflected light has a relatively steep drop-off in light intensity away from the brightest point. The reflected light from the center location of screen 112′ would be received as a concentrated spot at combiner 14; however, the reflected light from off-center locations of screen 112′ would tend to reflect away from combiner 14. As such, the viewer of combiner 14 in the example of FIG. 4b would see a “hot spot” in the center, with that hot spot moving with the angle at which the viewer views combiner 14 (for example, to the profiles indicated by the dotted line plots in FIG. 4b) so that, at any viewing angle, the image would have a very bright spot in one part while the rest of the image would be dark.

FIG. 4c illustrates the nature of the light reflected by substantially spherical high gain screen 12 as used in HUD device 2 according to these embodiments. In this example, as noted above, the radius of curvature of screen 12 is approximately twice that of the distance between projector engine 10 and screen 12, so that projector engine 10 is near what would be the focal point if screen 12 were a mirror. This curvature causes the reflected light ray bundles from off-center locations to be reflected roughly parallel to the light reflected from the center location of screen 12, rather mostly reflecting at an angle that would miss combiner 14. As shown in the light profile plot at the left-hand side of FIG. 4c, the result of the gain Gₓ and the curvature of screen 12 is an image that is quite uniformly bright, at an intensity nearly corresponding to gain Gₓ across the full dimensions of combiner 14. In effect, this construction of screen 12 as a high gain, substantially spherical curved, surface provides both the advantage of the high gain of screen 112′ in FIG. 4b, and the near uniformity of unity gain screen 112 in FIG. 4a.

According to these embodiments, substantially spherical screen 12 is capable of producing an image that can be perceived as bright as that provided by a flat unity gain screen, but from a low-power projector engine 10 (i.e., projecting light at 1/Gₓ brightness, for the screen 12 of gain Gₓ), with good uniformity in the brightness of the image at combiner 14. This ability to reduce the light intensity output by projector engine 10 reduces the power consumed and heat produced by HUD device 2, resulting in lower overall system cost. In addition, the high gain of screen 12 increases the rejection of light from directions other than from projector engine 10, such light including particularly ambient light, from being reflected to combiner 14.

According to these embodiments, the gain of screen 12 is not necessarily the highest gain that can be attained. If screen 12 were a highly reflective mirror (a pure mirror would have infinite gain), the image at combiner 14 would appear only as a bright rectangle of the same size as the image projected onto screen 12, and thus too small to be easily seen by driver DRV in the automotive context. It is therefore useful for screen 12 to somewhat diffuse the light reflected at its surface, spreading the reflected image to be wider than screen 12 itself.

According to these embodiments, screen 12 is constructed to have a very high gain, approaching that of a mirror, but with enough diffusion or other light scattering properties that the image is visible (i.e., so as to function as a “screen” rather than a “mirror”). For example, it is contemplated that screen 12 may be constructed to have a gain of at least 4.0, preferably 6.0 or greater and as high as at least about 20.0; these gains for screen 12 are very high, as compared with conventional projection screen gains of between 0.7 and 2.5. At these very high gains, screen 12 will behave as a slightly diffuse mirror, which contributes to the producing of a good image. The diffusion at the surface of screen 12 may be realized by selection of a somewhat rough material for the reflective inner surface of screen 12, by performing some roughening of the surface, or by applying a coating to that surface. In addition, as noted above, it may be desirable for screen 12 to be slightly aspherical, while remaining substantially spherical as described above to help correct for keystone and barrel distortion. These effects will result in a slightly different light profile, with a bit more spreading of the reflected light, and somewhat less uniformity of the reflected light intensity in the central region of combiner 14. This diffusivity at the surface of screen 12 results in the reflected light not being sharply focused at the surface of screen 12, which has been discovered, according to this invention, to improve the optical characteristics of screen 12.

Referring now to FIG. 4d, the construction of screen 12 according to an embodiment will now be described in further detail. As discussed above, the function of screen 12 is to diffuse the light projected on it by projector engine 10 to create a “real” (i.e., viewable) image at combiner 14. In this embodiment, the shape of screen 12, particularly the shape of its inner (i.e., concave) reflective surface, is substantially spherical as described above. In HUD device 2 according to these embodiments, screen 12 is preferably opaque so that light from projector engine 10 that is incident on its inner surface will not be transmitted by screen 12 through to driver DRV. As such, screen 12 according to this embodiment includes support structure 30 formed of glass, plastic, or other suitable support material from a structural standpoint that is itself opaque (i.e., light-absorbent) or is coated with a light-absorbent material (e.g., similar to the back of a mirror), and has a smooth or otherwise reflective inner (concave) surface 32 so as to reflect incident light at high gain, as discussed above Inner surface 32 can be constructed simply as the surface of support structure 30 itself, depending on its material, or as a material such as aluminum or stainless steel applied to support structure 30, or as a special screen plastic film, a metal film or foil, or another type of reflective coating that is applied to the surface of support structure 30. In any case, inner surface 32 of screen 12 should have a diffusion characteristic, whether inherent in its material, or attained by roughening or applying a coating to inner surface 32.

In the embodiment of FIG. 4d, screen 12 is constructed to take advantage of projector engine 10 in which the light sources are LEDs or lasers, which emit light within relatively narrow bands. According to this embodiment, these narrow bands can be leveraged to further enhance the optical performance and characteristics of HUD device 2, by applying dichroic coatings 34 to inner surface 32 of screen 12 as shown in FIG. 4d, with those dichroic coatings 34 tuned to the wavelengths of the LED and laser light sources. According to an embodiment, these dichroic coatings 34 can constitute a “triple bandpass filter” that passes the specific wavelength bands centered around three colors (red, green, and blue) of light emitted by projector engine 10, but excludes (e.g., by absorbing or transmitting through) light of other wavelengths, including much of the ambient light that may impinge on screen 12. The contrast of the image reflected to combiner 14 and viewed by driver DRV will thus be improved.

Other coatings may be applied to inner surface 32 of screen 12, for example to improve its mechanical characteristics, such as scratch resistance.

Due to its high screen gain, substantially spherically shaped screen 12 is highly directional. As such, in these embodiments screen 12 is tilted upwardly relative to the direction of projected light from projector engine 10, as shown in FIG. 3a. For optimum brightness, the angle of this upward tilt is less than that of angle θ between the projected light and the center of combiner 14, for example an upward tilt of about θ/2. In some embodiments, the location and tilt angle (e.g., θ/2) of screen 12 may be fixed; in other embodiments, screen 12 may be tiltable to adjust its aim toward combiner 14, or to close screen 12 for storage.

In some implementations, this tilt of screen 12 will cause the reflected image to be slightly “keystoned”, or wider at its top than at its bottom when viewed at combiner 14. As mentioned above, this keystone effect can be reduced optically, for example with a lens in projector engine 10 or by constructing screen 12 to have a slightly aspheric inner surface, or digitally, for example by pre-processing the image data to compensate for the keystoning and provide an undistorted image at combiner 14, or by a combination of optical and digital correction. If desired, such pre-processing to correct for “keystoning” can be based in part on information from rear facing camera RCM so that the digital adjustment and pre-distortion can account for differences in the driver's eye location, considering that the apparent size of the image at combiner 14 will change according to the distance between the driver's eyes and combiner 14.

According to other embodiments, as shown in the side cross-sectional views of FIGS. 4e through 4g (i.e., taken in the same direction as FIG. 3a), screen 12 may be constructed to have variations on its inner concave surfaces. Referring first to FIG. 4e, screen 12e is shown as having an inner surface formed as piece-wise segments, with each segment reflecting the projected image with an upward tilt, toward combiner 14. One aim of this piecewise tilt is to reduce or eliminate upwardly tilting the entire screen 12, which reduces or eliminates keystone image distortion and variations in focus of the image. The relative lengths of these piecewise sections shown in FIGS. 4e through 4g are for explanatory purposes only, as it is contemplated that these piecewise sections may be made extremely small so as to reduce visible artifacts of the piece-wise segment boundaries in the image at combiner 14. As shown in screen 12f of FIG. 4f, the piece-wise sectioned inner surface may be combined with an overall spherical curvature.

According to another embodiment as shown in FIG. 4g, screen 12g is constructed as a “Fresnel Screen”, where the curvature of the screen is realized by flattening the original curvature of the spherical screen (shown in FIG. 4g by the dashed lines) piecewise, as known in the art for Fresnel lenses and mirrors. However, unlike a Fresnel mirror, the inner surface of screen 12g will be somewhat diffuse, as described above, so that a “real” image will appear when light is projected upon it. The size of the piece-wise segments of Fresnel screen 12g may be of any size, including very small (as small as microscopic), so as to reduce any noticeable visible effects in the reflected image.

As discussed above, combiner 14 is a semi-transparent curved element that combines light from windshield WSH with the images reflected on its inner surface from screen 12, forming a combined image perceivable to driver DRV. In addition, combiner 14 in these embodiments magnifies the image that is projected on screen 12, which allows screen 12 to be vertically shorter and thus facilitating visibility of combiner 14 to driver DRV, over the top of screen 12. In addition, as will be described in further detail below, the arrangement and shape of combiner 14 is effective to move the focus of the perceived image further away from driver DRV than its actual position. As a result, combiner 14 in these embodiments will place that image into the far vision of driver DRV, thus making it easier for him to focus on the image presented by HUD device 2 along with the road, traffic, and other things in the distant external view in front of the vehicle.

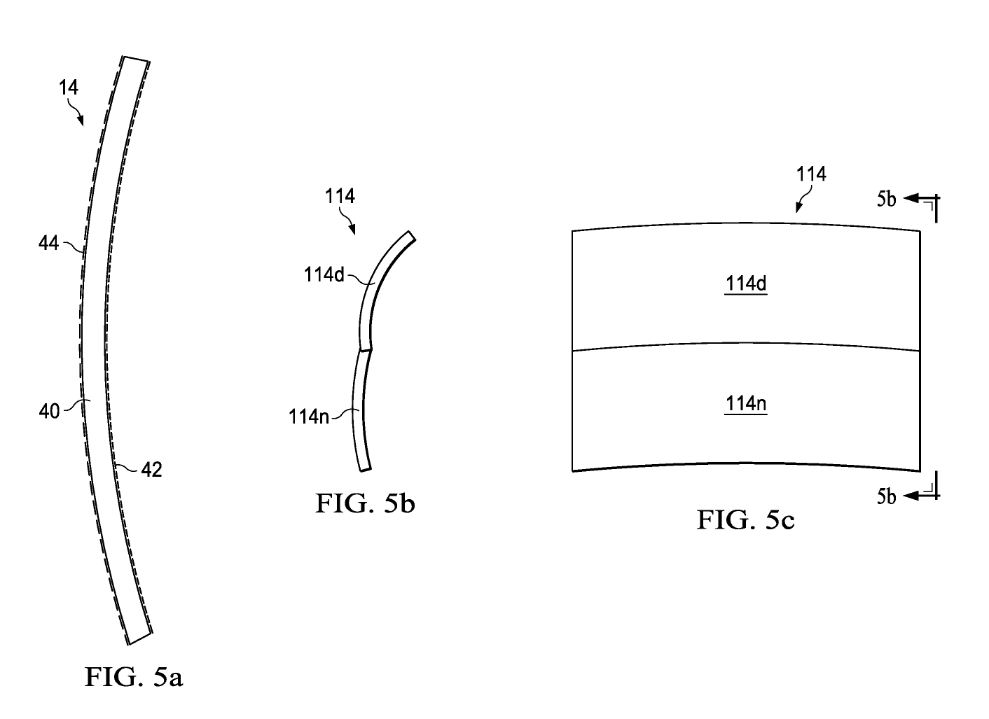

According to one embodiment shown in cross-section in FIG. 5a, combiner 14 includes, as its primary structural element, transparent optical element 40 formed of polycarbonate (e.g., UV stabilized polycarbonate) or another transparent plastic, or of a glass material, either preferably being of optical quality. It is contemplated that optical element 40 will typically be on the order of several millimeters thick. As evident from this description, in order to perform its function of combining external light with a reflected image, optical element 40 defines an outer surface (i.e., the convex surface) that transmits incident light received at that surface, such as through windshield WSH in the arrangement of FIG. 3a, and an inner surface (i.e., the concave surface) that reflects the incident light reflected onto it from screen 12.

According to the embodiment shown in FIG. 5a, optical element 40 has reflective coating 42 on its inner surface to provide the reflective properties necessary for driver DRV to view the image projected onto screen 12. Various materials are suitable for coating 42, including a mirror coating such as vapor-deposited aluminum or other metal, which will reflect most wavelengths fairly equally. Coating 42 will preferably not be totally reflective for light directed from screen 12 (i.e., toward the concave surface of combiner 14); for example, in one example coating 42 of vapor-deposited aluminum is about 30% reflective to light from screen 12, and about 70% transmissive to light coming from the opposite direction (i.e., from windshield WSH in the arrangement of FIG. 3a). According to another implementation, coating 42 may be implemented as a conventional dichroic reflective coating such as discussed above relative to screen 12, so as to implement a triple bandpass filter that reflects the colors of light emitted by projector engine 10, while being largely transparent to external visible light passing through windshield WSH and impinging on the outer surface of combiner 14. For example, if projector engine 10 includes lasers as the light source, coating 42 could be selected to have relatively narrow reflective wavelength bands, and thus very wide passbands to pass the external light from the front of the vehicle. This construction would also result in little sunlight entering the vehicle from the rear from being reflected back to the eye of driver DRV, which would improve the contrast of the viewed image at combiner 14 in bright sunlit conditions.

In this arrangement of HUD device 2, the real image on screen 12 is magnified and reflected in the direction of driver DRV by combiner 14 as a virtual image. As such, the focal length and placement of combiner 14 will determine the magnification and apparent image focus distance of that virtual image. As is well understood in the art, an object (in this case, the image at screen 12) viewed in a concave spherical mirror (in this case, combiner 14) will be magnified, with the apparent focus point varying as a function of the focal length of the mirror, the distance of the object from the mirror, and the distance of the observer from the mirror. In such a mirror, the reflected image of an object located between the focal point and the reflective concave surface will be magnified, and will appear to be “virtually” further away to the eye both in terms of focus and location than the object is physically. Generally, as the object approaches the focal length of the mirror the magnification increases and the object appears to be further behind the mirror both in location and focus. As mentioned above, it is preferred that the virtual image at combiner 14 should appear in the distance (e.g., at “infinity” in the optical sense) beyond combiner 14 from driver DRV, so that he can easily view the displayed information without taking his eyes off the road.

The distance of curvature of combiner 14 from screen 12 and the radius of curvature of combiner 14 are selected according to these concepts, as will now be described in connection with this embodiment of the invention. As a matter of physics, a reflective substantially spherical surface of radius “R” will have a focal point of R/2. For purposes of this description, the radius of combiner 14 will be defined as the general curvature of the inner surface of optical element 40; generally, the outer side of combiner 14 will have a radius of curvature that differs from that of its inner side by about the thickness of optical element 40. It has been observed that light which passes through a transparent spherical element, such as optical element 40, that has inner and outer surfaces with similar radii of curvature will be minimally distorted and its magnification minimally affected. Because the distance that the reflected virtual image at combiner 14 appears in the distance increases as the distance between screen 12 and combiner 14 approaches the focal length of combiner 14, that distance from combiner 14 to screen 12 should be as large as possible without exceeding the focal length of combiner 14. Conversely, if this distance exceeds the focal length of combiner 14, the image becomes unstable. In one implementation, for example, a radius of curvature of on the order of about 300 mm for the inner surface of optical element 40 was selected, resulting in a focal length of about 150 mm for combiner 14. In this implementation, the distance between combiner 14 and screen 12 of about 115 mm was selected, to provide 45 mm of margin to avoid the potential for this instability, especially considering the adjustability of screen 12 and combiner 14 as described below. In that arrangement, with the distance between screen 12 and combiner 14 being <½ the radius of curvature of combiner 14, provides driver DRV with a view outside of windshield WSH through combiner 14 with minimal distortion and magnification due to combiner 14, in combination with a magnified virtual reflected image from screen 12 on the inner surface of combiner 14 that appears to be at a distance farther in front of driver DRV than combiner 14 actually is. In these embodiments, optical element 40 and thus combiner 14 is preferably curved to be a “substantially spherical” surface, meaning that its surface is not perfectly spherical but is sufficiently close to being spherical so as to behave similarly to a perfectly spherical surface within the context of these embodiments. It has been discovered, according to these embodiments, that providing a slightly aspherical but still substantially spherical inner surface of combiner 14 can help to correct for keystone and barrel distortion in the image as reflected to it from screen 12.

In the embodiment shown in FIG. 5a, combiner 14 also has antireflective coating 44 disposed on its outer, or convex, surface, to improve light transmission in both directions through optical element 40, and to reduce double images from being apparent to driver DRV. It is contemplated that antireflective coating 44 may be formed of a conventional material for such coatings as known in the art, and applied to optical element 40 in the conventional manner.

FIGS. 5b and 5c illustrate “multiple range” combiner 114, according to another embodiment. Multiple range combiner 114 is constructed to have more than one focal length, in this implementation by having upper portion 114f with a different radius of curvature and thus a different focal length than lower portion 114n, with an abrupt transition between the two as shown. Alternatively, combiner 114 could be constructed to have a smooth transition between the different focal length portions, for example with a gradual transition in focal length similar to progressive focus eyeglasses. The differences in radius of curvature could be implemented on both the concave and convex sides of combiner portions 114f, 114n, or alternatively only on the convex side (i.e., maintaining a constant radius of curvature on the outer surface by varying the thickness of the optical element. In the example of FIGS. 5b and 5c, upper portion 114f has a shorter radius of curvature and thus a shorter focal length than lower portion 114n. As a result, since portions 114f, 114n are at essentially the same distance from screen 12, the reflected image from screen 12 on upper portion 114f with the shorter focal length will appear further away, and will be more magnified than that in lower portion 114n. Variations in this alternative construction are also contemplated, for example more than two magnifications could be realized by providing additional portions; further in the alternative, the different magnification portions may be realized side-by-side, rather than in the upper and lower arrangement of FIGS. 5b and 5c.

Referring back to FIG. 3a, the overall functionality of the arrangement of projector engine 10, screen 12, and combiner 14 in HUD device 2 according to this embodiment will now be described. As previously described, projector engine 10 projects light along image path IMG_10 toward screen 12, forming a real (human-viewable) image at screen 12 corresponding to information generated by control electronics 6, for example at the request of driver DRV or as otherwise relevant in the operation of the vehicle. Because screen 12 is tilted upward (e.g., by an angle θ/2) and has an inner reflective surface as described above, that image is in turn is reflected along image path IMG_12 to combiner 14. Combiner 14, which is semi-transparent as described above, both reflects that “virtual” image from its inner surface and also transmits external light received through windshield WSH, with the combination resulting in an image that is viewable to driver DRV along center line-of-sight CLOS.

As noted above, screen 12 has a substantially spherical inner surface with a radius of curvature that is about twice of its distance from projector engine 10. As a result, projector engine 10 is at a distance from screen 12 about at the focal point of its curved reflective inner surface, so that a real image appears at screen 12. For example, one implementation of HUD device 2 according to this embodiment includes screen 12 having an inner high-gain reflective surface with a radius of curvature of about 200 mm, positioned at a distance of about 100 mm from projector engine 10. This inner surface of screen 12 slightly diffuses that real image, for example by roughness or a coating, so that this real image at screen 12 is visible but not sharply focused. This inner surface of screen 12 has a high gain, however, such that the light it reflects is of excellent brightness and, because of the upward tilt of screen 12, is directed relatively uniformly across a large portion of combiner 14. Additional features of screen 12, such as dichroic coating 34 at its inner surface so as to provide a bandpass filter for the projected light components, and piece-wise shaping of that inner surface as described in FIGS. 4e through 4g, may optionally be provided to further enhance the optical performance of screen 12 in the arrangement of HUD device 2 according to this embodiment.

Combiner 14 is located at a distance along path IMG_12 in FIG. 3a that is less than one-half the radius of curvature of the inner surface of semi-transparent combiner 14, which is positioned above projector engine 10. This positioning and shape of combiner 14 magnifies the image reflected by screen 12 as it appears at combiner 14, reflecting that magnified image at an apparent focal point that is further in front of driver DRV than the physical location of combiner 14 itself. The image on the screen, seen by the user to be magnified and more distant, is considered by those skilled in the art to be a “virtual image”, such that movement of the head of driver DRV will also “move” the image at combiner 14, thus providing good viewability of the displayed image over a wide angle. The magnification of the virtual image on combiner 14 relative to the real image at screen 12 enables screen 12 to be physically shorter, in the vertical dimension, which makes it easier for driver DRV to see over screen 12 to see the image on combiner 14. Because of the semi-transparent nature of combiner 14, this magnified, distant focus, image is combined with the external view transmitted through combiner 14 from its front, outer surface, from the viewpoint of driver DRV. The result of this arrangement of HUD device 2 according to this embodiment thus conveniently provides driver DRV with relevant information as generated by control electronics 6, without requiring driver DRV to significantly change his focus from the road ahead in order to see that information. This beneficial result is provided, according to this embodiment, by HUD device 2 that can be packaged in a convenient portable dashboard-top module, easily movable and removable, and deployable in a wide range of automobiles, trucks, and other vehicles.

It has been discovered, in connection with this invention, that the placement of projector engine 10 near the back of HUD device 2 (i.e., farthest away from driver DRV) under combiner 14, and above control electronics 6, provides several advantages. By locating projector engine 10 as far away from screen 12 as possible, within the bounds of housing 4, the necessary tilt angle of screen 12 can be reduced, which in turn reduces the keystone distortion. In addition, because the radius of curvature of screen 12 is optimally about twice the distance between projector engine 10 and screen 12, in order for projector engine 10 to be near the focal point of screen 12, maximizing this distance allows for the radius of curvature of screen 12 to be as large as possible, minimizing distortion in the image reflected from screen 12 to combiner 14 (closer placement of projector engine 10 would require screen 12 to have a shorter radius of curvature, which increases distortion of the image). Placement of projector engine 10 above control electronics 6 ensures that the printed circuit board or boards on which control electronics 6 are deployed will not interfere with the light path between projector engine 10 and screen 12, relaxing the form factor constraints for the components in control electronics 6, and also providing a more compact product design.

In addition, FIG. 3a illustrates housing 4 as having a “light hood” 4H that extends rearward toward driver DRV, above and beyond projector engine 10. Light hood 4H helps prevent driver DRV from seeing the lens of projector engine 10 directly over the top of screen 12, which would appear uncomfortably bright to the eye. Light hood 4H of course should not block the projected image to screen 12 nor the light of the image reflected form screen 12 to combiner 14. In some implementations, these limitations may limit the ability of light hood 4H to totally block the direct view of the lens of projector engine 10, especially considering that it is desirable to have screen 12 as short as possible to limit the tilt angle θ and thus the keystone distortion as noted above. In those implementations, therefore, adjustable “direct light lens block” 17 may be provided near the back (driver side) of screen housing 13, and may preferably be raised or lowered to block the light depending on the particular installation. Direct light lens block 17 may be all or only a part of the screen housing 13.

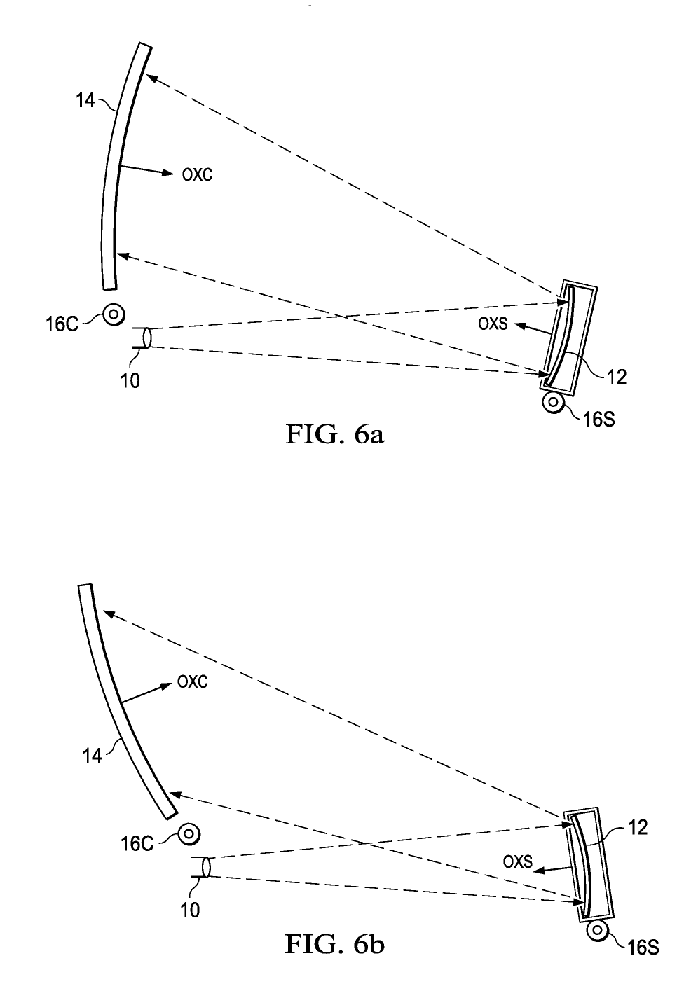

In this embodiment, hinges 16C, 16S couple combiner 14 and screen 12, respectively, to housing 4, allowing rotation of each of those elements as may be useful for a particular placement atop dashboard DSH and to reduce distortion in the image as viewed. While some embodiments may include only hinge 16C, to ease the adjustment process for the user over a range of installations, including both hinges 16C and 16S can provide additional ability to optimize the image fidelity, as will now be described by way of example in connection with FIGS. 6a and 6b. In FIG. 6a, combiner 14 and screen 12 are tilted by hinges 16C, 16S, respectively, to provide the optimal view to driver DRV for a particular placement of HUD device 2. Optical axes OXC and OXS of combiner 14 and screen 12, respectively, shown in FIG. 6a, are the axes of revolution of these respective substantially spherical surfaces, in the manner known in the art. In this arrangement of combiner 14 and screen 12 in HUD device 2, as optical axes OXC and OXS become less parallel to one another, distortion and aberrations in the image reflected from screen 12 to combiner 14 will increase. As such, optimum fidelity in the image viewed at combiner 14 is attained by rotating combiner 14 and screen 12 by way of hinges 16C, 16S so that optical axes OXC, OXS are maximally parallel. FIG. 6b illustrates an example of an installation of HUD device 2 in a different vehicle from that of FIG. 6a, such as a vehicle with a lower dashboard DSH so that combiner 14 must be rotated to obtain a viewable image. In this embodiment, combiner 14 and screen 12 can both be rotationally tilted via their respective hinges 16C, 16S, to not only ensure that direct light from projector engine 10 is properly reflected from screen 12 into combiner 14 in a viewable position by driver DRV, but also to optimize fidelity of the image. As shown in FIG. 6b, the cooperative rotation of screen 12 by way of hinge 16S along with the rotation of combiner 14 by hinge 16C allows the respective optical axes OXS and OXC to be in a maximally parallel orientation relative to one another, minimizing distortion and aberrations in the image. Fidelity in the image displayed at combiner 14 can thus be maintained over a wide range of vehicles and dashboard heights and shapes according to this embodiment.

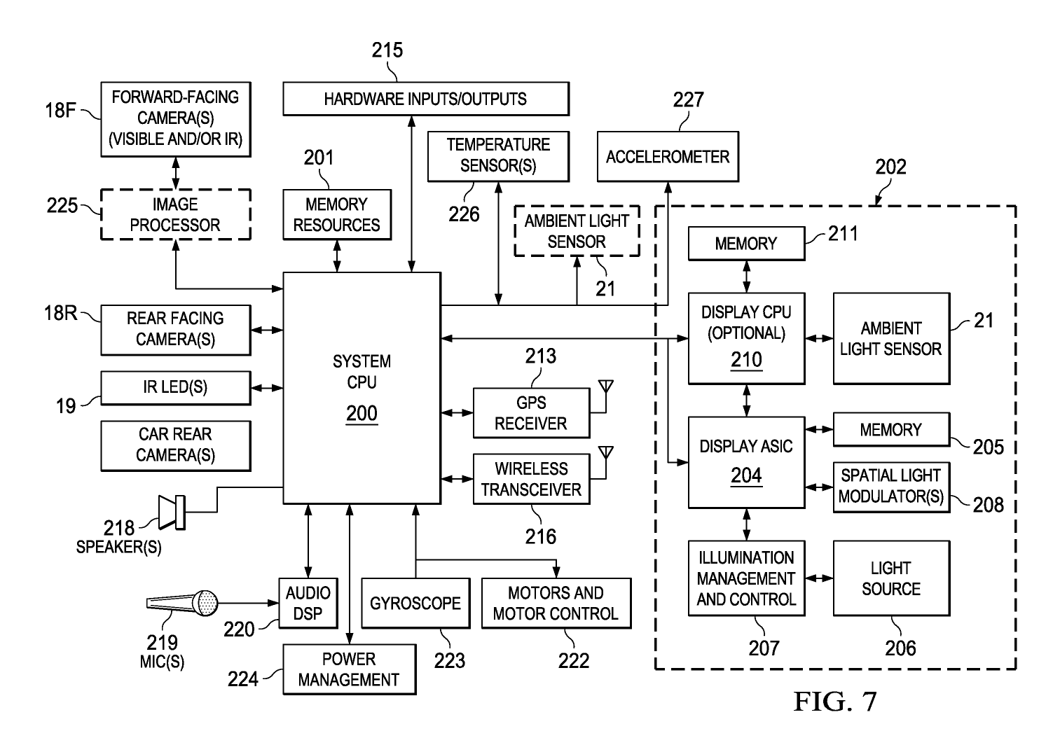

FIG. 7 illustrates, in block diagram form, a generalized functional architecture for control electronics 6 according to these embodiments, including functional components and features that may individually, or in some combination, optionally be included within particular realizations of HUD device 2. As such, not all implementations are contemplated to include every one of these components and features, but rather this description and architecture is provided merely to illustrate many types of functions that may be included as desired by the system designer and integrator. In addition, multiple ones of the functions shown may be integrated into a single integrated circuit, along with other functions as appropriate. In any case, it is contemplated that those skilled in the art having reference to this specification will be readily able to implement the desired functions into the appropriate integrated circuits and discrete components as appropriate for particular implementations, without undue experimentation.

As shown in this architecture, the primary functions in control electronics 6 for carrying out the basic functionality of HUD device 2 include system CPU 200 and display subsystem 202, which are coupled to one another by way of the appropriate bus connections. System CPU 200 may be realized by way of a full-fledged processor system, such as an ARM CPU with one or more “cores”, cache memory, and on-board peripheral including but not limited to a video controller and other possible functions. An example of a suitable processor type for system CPU 200 in these embodiments is the ARM CORTEX-A9 i.MX6 Series multicore processors available from Freescale Semiconductor. Memory resource 201 in communication with system CPU 200 typically includes conventional random access memory (RAM) as main data memory, and non-volatile storage such as flash memory or the like for program storage and non-volatile data memory, as known in the art.

Display subsystem 202 includes the appropriate electronics for generating images for display via projector engine 10. While an example of the architecture of display subsystem 202 is provided in this specification, the exact display system will vary according to the display device requirements as will be understood by one skilled in the art. In the example of FIG. 7, display electronics 202 includes display ASIC 204, which executes program instructions stored in memory 205 or executes control logic to control the power of light source 206 (e.g., lasers or LEDs) via illumination management and control 207, and to control spatial light modulators (SLM) 208. As mentioned above, examples of SLM 208 suitable for use in this embodiment may include one or more DMD, LCOS, or LBS devices that modulate the light issued by light source 206 in the conventional manner. Memory 205 may include RAM or other working memory for processing and reformatting images to meet the SLM requirements, and may include non-volatile storage of control information such as resolution for the SLM, and data regarding the LEDs at various brightness levels as is commonly used for white balancing.

Display subsystem 202 may also include its own additional computational capacity for controlling SLM 208 and light sources 206, for example as provided by optional display CPU 210 shown in FIG. 7, along with its own corresponding program and data memory resource 211. For example, it is contemplated that many implementations of HUD device 2 will require a very wide dimming range for the display corresponding to the wide range of ambient light that may be experienced in an automotive interior, ranging from bright ambient sunlight to the dark of night. Over this wide range, it can become difficult to control LED light sources 206, and as such it may be desirable to incorporate light sensor feedback into the system. In the example of FIG. 7, display CPU 210 receives signals from one or more ambient light sensors 21 (FIG. 2c and FIG. 7), and responds to those signals by controlling the level of illumination by light sources 206 and perhaps the operation of SLM 208, along with pre-selected user brightness preferences, without burdening system CPU 200. Optionally, ambient light sensor 21 may be coupled directly to system CPU 200, as suggested by FIG. 7.

A number of optional functions may also be provided within control electronics 6, as shown in FIG. 7, depending on the particular implementation. Typically, it is contemplated that hardware inputs/outputs 215 may provide one or more ports such as a flash/SD card port, USB connection, audio in, audio out, and the like as would be found on a modern computing system. One of hardware input/outputs 215 may also be provided for wired communication with the on-board diagnostic port (OBD) of the vehicle. Wireless transceiver 216 is provided for communicating with nearby devices such as smartphone SPH, the vehicle audio system, the vehicle on-board diagnostic port and other in-car functions, wireless sensors elsewhere in or on the vehicle such as proximity detectors and vehicle cameras and the like, and may operate according to one or more conventional near-field communication facilities such as Bluetooth, NFC, infrared (IR) and the like.

HUD device 2 may include its own audio capability, including either or both of speakers 218 and microphone 219; if so, or even for receiving and producing audio signals via the vehicle audio system, audio DSP 220 may be provided for carrying out the appropriate digital processing, speech recognition and synthesis, and the like. GPS receiver 213 may also be provided as part of control electronics 6, and coupled to system CPU 200 for processing of positional information. In some embodiments, gyroscope 223 may be implemented within housing 4, to help stabilize HUD device 2 from vibration and other movement in one or more directions by way of one or more motors, also deployed within housing 4 or in a mounting structure by way of which housing 4 is mounted to dashboard DSH, that reduce movement of the entire HUD device 2 or only movement of one or more of the optical structures, such as a lens or mirror in projector engine 10, so as to reduce the image movement as seen by driver DRV. In this case, motor control 22 coupled to and controllable by system CPU 200 in control electronics 6 may be provided to control those vibration compensation motors, or one or more other optional motors such as may be implemented to tilt or move combiner 14.

Power management function 224 is provided to control power for control electronics 6, and convert voltages to those appropriate for operating the various functions. It is contemplated that power management function 224 may receive system power from one or more power sources, including vehicle or house power, a USB connection or other wired power source, one or more batteries, one or more solar or other devices such as an inductive connection for providing power to either run the device or charge some form of battery, and as such power management function 224 will typically include the associated charging circuitry. If batteries are provided, this power source can be used for keeping all or part of the system powered for a period of time if power is interrupted; power management function 224 may then “wake up” control electronics 6 in response to an event, such as using information from accelerometer 227 (or another type of motion sensor) to detect that the vehicle has been disturbed.

One or more temperature sensors 226 at one or more locations of control electronics 6 or elsewhere in HUD device 2 can be provided to sense the system temperature. This temperature information may be used to issue warnings, and possibly to cause parts of the system to shut down in order to protect them, or could be used to adjust the brightness of one or more colors of the LEDs and/or lasers in light source 206 to compensate for temperature effects. For example, on a hot day sitting in the sun, HUD device 2 could become so hot that some of the devices such as display subsystem 202 or light source 206 could be damaged if operated; in this case, system CPU 200 could execute software to decide whether power on a fan or not to power on display subsystem 202 and light source 206 until the temperature has come down to an acceptable level.

According to some embodiments, HUD device 2 generates images projected by projector engine 10 and appearing on combiner 14 in response to inputs from driver DRV. Safety favors that driver DRV can provide inputs to HUD device 2 in such a way that does not detract from control of the moving vehicle or from driver DRV keeping his eyes on the road ahead. In the embodiment of HUD device 2 described above, including the architecture for control electronics 6 shown in FIG. 7, these inputs include gestures made by driver DRV as detected by way of rear-facing camera 18R, as shown in FIGS. 2a and 2b; alternatively, other types of sensors, such as capacitive, electromagnetic, ultrasonic, and other sensors understood in the art of gesture recognition may be additionally or alternatively to rear-facing camera 18R. Multiple rear-facing cameras 18R may also be implemented to aid gesture recognition by improving depth perception. In addition, multiple rear-facing cameras 18R may include one camera sensitive to visible light to detect gestures during daylight use, and another sensitive to infrared (IR) to capture gestures during nighttime use. These gestures by driver DRV, in combination with voice commands received via microphone 219 or alternatively received via a connected device such as smartphone SPH or the vehicle audio system and wirelessly communicated to HUD device 2, provide a wide range of functionality for which visual content may be displayed at combiner 14.

Other cameras and sensors beyond those specifically mentioned in this specification may additionally or alternatively be implemented as appropriate.

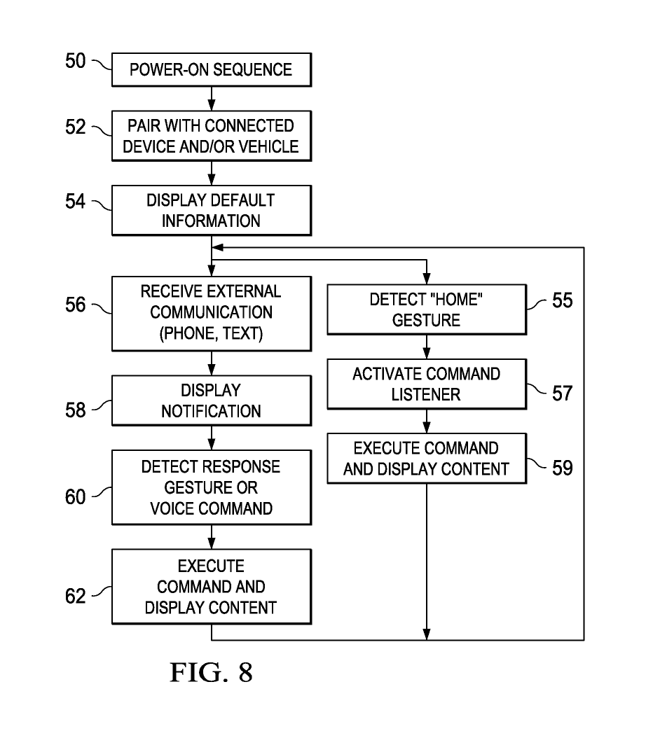

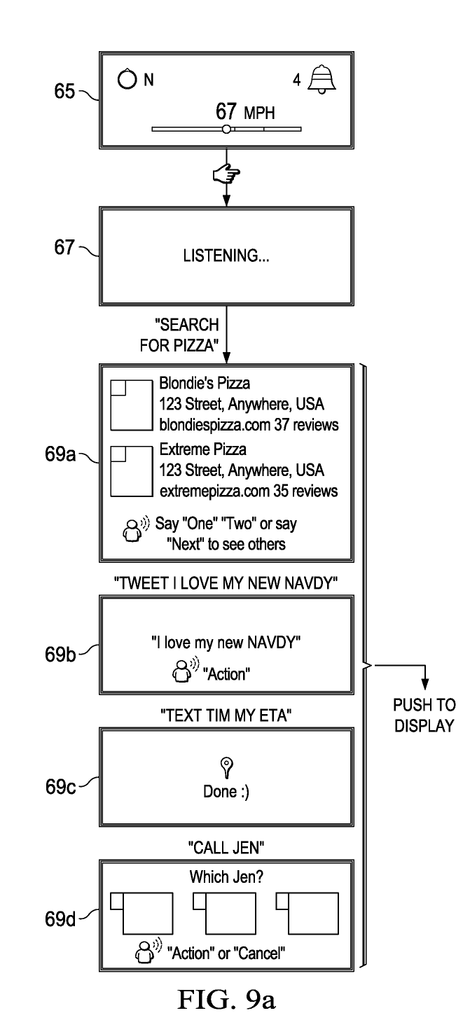

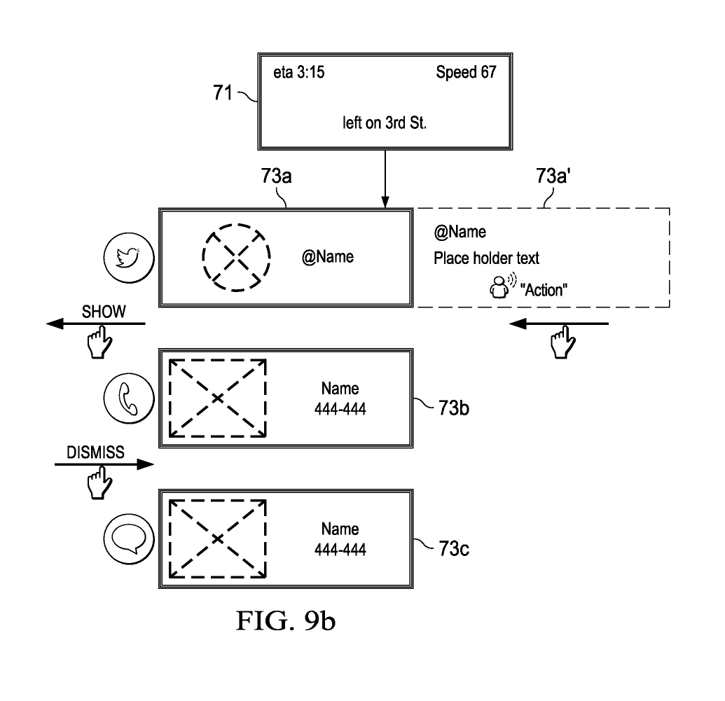

Referring now to FIGS. 8, 9a and 9b, an example of the operation of control electronics 6 in projecting visual content at combiner 14 by way of projector engine 10 and screen 12, and combiner 14 in response to gestures by driver DRV as detected by rear-facing camera 18R, according to an embodiment, will now be described.

FIG. 8 is a flow diagram illustrating the generalized operation of HUD device 2 including its response to driver gestures and commands. Power-on sequence 50 begins with the powering-on of HUD device 2, including execution of the appropriate initialization routines by system CPU 200, power-on self-test sequences, and the like. In process 52, system CPU 200 executes the appropriate routines to pair its communications with the various devices in its vicinity, including smartphone SPH and perhaps certain functions of the vehicle, including the vehicle audio system, the on-board diagnostic port OBDP, rear-mounted vehicle camera RCM, and the like, as available and enabled for this installation. Following power-on sequence 50 and pairing process 52, control electronics 6 places HUD device 2 in a default condition in process 54, and forwards the corresponding image data to projector engine 10 for display at combiner 14. It is contemplated that this default condition may be to display the current velocity of the vehicle, or the current location on a navigation system map, or even simply a “splash” screen at combiner 14 in the field of view of driver DRV. At this point in its operation, HUD device 2 is ready to receive commands from driver DRV, or to respond to incoming communications. It is contemplated that rear-facing camera(s) 18R and other functions associated with control electronics 6 are operable, in this default state, to receive input from driver DRV or over the communications network, as appropriate.

According to this embodiment, driver DRV can invoke a function by HUD device 2 by making a pre-determined hand gesture that is detected by rear-facing camera 18R in process 55. This “home” gesture may be a “thumbs-up” gesture, a “two-fingers up” gesture, or some other distinctive hand position or motion, preferably made by driver DRV above steering wheel SWH (FIG. 1) so as to be in the field of view of rear-facing camera 18R. In the architecture shown in FIG. 7, rear-facing camera 18R forwards images to system CPU 200; in process 55, system CPU 200 in turn executes image recognition routines to detect the pre-determined “home” gesture for indicating that driver DRV wishes to present a command to HUD device 2. An example of this operation is shown in FIG. 9a, in which the default state displayed in process 54 is image 65, which includes such information as the current velocity of the vehicle, the direction of travel, and a number of pending reminders are displayed as shown. Upon detecting the pre-determined “home” gesture in process 55, in this example a “thumbs-up” gesture, process 57 is then executed by system CPU 200 to activate an audio command listener routine. In this process 57, control electronics 6 issues the data to projector engine 10 to display a “listening” image at combiner 14, for example as shown by image 67 in FIG. 9a. The appropriate speech recognition routines are then executed by system CPU 200 to detect the content of a voice command received over microphone 219, smartphone SPH, or the appropriate audio input facility.

According to this embodiment, a relatively wide range of audio commands may be available for execution by system CPU 200 in process 59. FIG. 9b illustrates a few such commands by way of example, including “search” for executing an Internet search for a type of business (e.g., “pizza”); “tweet” for creating a short text message to be posted on the TWITTER social network, via smartphone SPH; “text” for creating a text message to be sent to a contact via the telecommunications network; “call” for making a telephone call via smartphone SPH; and other such commands including invocation of a navigation function. In response to receiving one of these audio commands, system CPU 200 executes the corresponding command and displays the corresponding content in process 59; for example by pushing one of images 69a through 69d to be displayed at combiner 14, in the example of FIG. 9a. Of course, additional voice commands or hand gestures may be required in the execution of the command of process 59 (e.g., confirming a text or tweet by way of a hand gesture or a “send” voice command). It is contemplated that those skilled in the art having reference to this specification will be readily able to implement such functionality as appropriate for a particular implementation.

Following execution of the command in process 59, control electronics 6 then returns to await further instruction or to respond to incoming communications, as the case may be, with the then-current image being displayed at combiner 14. Those then-current image may be the default state, such as image 65 of FIG. 9a, or they may be the result of the command executed in process 59, for example navigation information regarding the next turn to be made toward the desired destination, as shown by image 71 of FIG. 9b.

In response to receiving an external communication in process 56, for example as communicated by the connected device (smartphone SPH) in response to it receiving a communication, control electronics 6 produces and displays a notification at combiner 14 corresponding to that external communication, in process 58. FIG. 9b illustrates examples of notifications displayed by HUD device 2 in response to receiving an external communication. Image 73a illustrates the notification for a “tweet” received over the TWITTER social network, including the profile photo of the “tweeter” and their screen name, and images 73b, 73c illustrate the notifications for an incoming phone call and incoming text message, respectively, each including the contact name or “caller ID” indication for the caller and their phone number. These notifications may include secondary information, such as image 73a′ that is not immediately displayed with notification image 73a but is available on command.

According to this embodiment, hand gestures or voice commands from driver DRV provide inputs for controlling responses to incoming notifications. These gestures and commands are detected using routines executed by system CPU 200 in response to inputs from rear-facing camera 18R and microphone 219, for example, in process 60. For example, if secondary notifications such as image 73a′ are available, driver DRV indicates the desire to view that secondary notification by making a leftward swipe with one finger raised; this hand gesture is detected by system CPU 200 in process 60, to which control electronics 6 responds in process 62 by displaying image 73a′. At this point (as indicated by the “listening” icon in image 73a′), voice commands issued by driver DRV (e.g., “retweet”, “reply”, etc.) may be detected in another instance of process 60, and the appropriate action taken by control electronics 6 in process 62. Alternatively, in the example shown in FIG. 9b, the hand gesture of a rightward swipe with one finger raised by driver DRV that is detected in process 60 will cause control electronics to “dismiss” the notification in process 62, returning the display to its previous state (e.g., navigation image 71) or to the default image (e.g., speedometer image 65), awaiting the next gesture, command, or incoming communication.

It is contemplated that those skilled in the art having reference to this specification will be readily able to recognize additional functions as may be provided by HUD device 2 and its control electronics 6, either itself or by way of a connected device such as smartphone SPH, and to realize those functions in a particular implementation, without undue experimentation.

One type of such an additional function is the generation of secondary images by display subsystem 202. For example, HUD device 2 may additionally include an ultraviolet (UV) wavelength LED or laser inside housing 4, or external to housing 4 but controllable by display subsystem 2, and the windshield side of combiner 14 may be coated with a thin phosphor or other layer that is stimulated by UV light. In this alternative arrangement, display subsystem 202 may control the UV LED or laser to generate images onto the externally-visible surface of combiner 14 causing it to glow, for example to project a logo or other symbol image for viewing by other drivers or passersby.

In some embodiments, HUD device 2 may function primarily as a simple display device for an attached computing device, such as smartphone SPH in the system diagram of FIG. 2c, in which case control electronics 6 would generate the appropriate graphics data to serve as a display for applications running on the attached computing device. In this arrangement, HUD device 2 would then leverage features implemented on that attached computing device, which may include connection to the internet, GPS, or other forms of communication, and could be realized by way of less circuitry than in more computationally capable implementations, retaining as little as only that functionality involved in operating the display, for example the functionality for controlling projector engine 10 in response to ambient light sensors 21 to adjust the brightness. In other embodiments, HUD device 2 itself could be a complete computing platform on its own as described above relative to FIG. 7, or may have some intermediate level of functionality in which some of the computing is carried out by control electronics 6 with other operations performed on the attached computing device.

As mentioned above, sensors in addition to or in place of rear-facing camera 18R may be used in gesture detection according to these embodiments, such sensors including digital cameras, infrared cameras, and sensors using capacitive, electromagnetic (e.g., radar), ultrasonic, and other mechanisms, as known in the art. In one embodiment, rear-facing camera 18R is an infrared (IR) camera that can be used to capture gestures during nighttime use. In this embodiment, an example of which is shown in FIG. 2b, IR illuminant 19 (e.g., an infrared-emitting LED) is provided so as to illuminate driver DRV during night conditions. It has been observed, according to this embodiment, that placement of IR illuminant above IR camera 18R greatly reduces the potential for shadowing of the gestures by steering wheel SWH. In addition, it has been observed, according to this embodiment, that illumination by IR illuminant 19 at a reduced duty cycle (e.g., below about 15%) is sufficient for gesture detection, without causing the driver discomfort that can occur at higher IR duty cycles.

According to some embodiments, forward-facing camera 19F may be incorporated into HUD device 2, for example mounted on the top of combiner 14 as shown in FIG. 2a. Forward-facing camera 19F provides visibility to control electronics 6, either directly to system CPU 200 or as processed by an optional image processor 225 (FIG. 7) to detect and process visible and/or invisible light. Forward facing camera 19F may, for example, capture images that image processor 225 or system CPU 200 (or both) may interpret to detect lane markers and boundaries, and use that information to detect where the vehicle is relative to the roadway, including the lane that the vehicle is currently in, or whether the vehicle has drifted off the road, or is weaving, and warn driver DRV accordingly. Other information in the images acquired by forward-facing camera 19F may include traffic information, information from signs, hazards such as vehicles stopped on the side of the road, and the like. The image information acquired by forward-facing camera 19F may also be processed and combined by either or both of image processor 225 or system CPU 200 with signals from GPS receiver 213, integrated circuit gyroscope sensor 223, accelerometers 227, or other sensors in HUD device 2, for example to obtain location, direction, velocity, and other results for display at combiner 14. In addition, information from external or connected rear cameras RCM (FIG. 2c) may be combined by system CPU 200 to provide information such as the safety of lane changes, assistance with parking, and the like. In addition, images from rear facing camera RCM may be processed by image processor 25 or system CPU 200 to detect whether the driver's eyes have been closed for a significant period of time; if so, for example if open eyes are not detected within a pre-selected period of time, HUD device 2 may issue an audible, visual (flashing lights), or vibration warning.

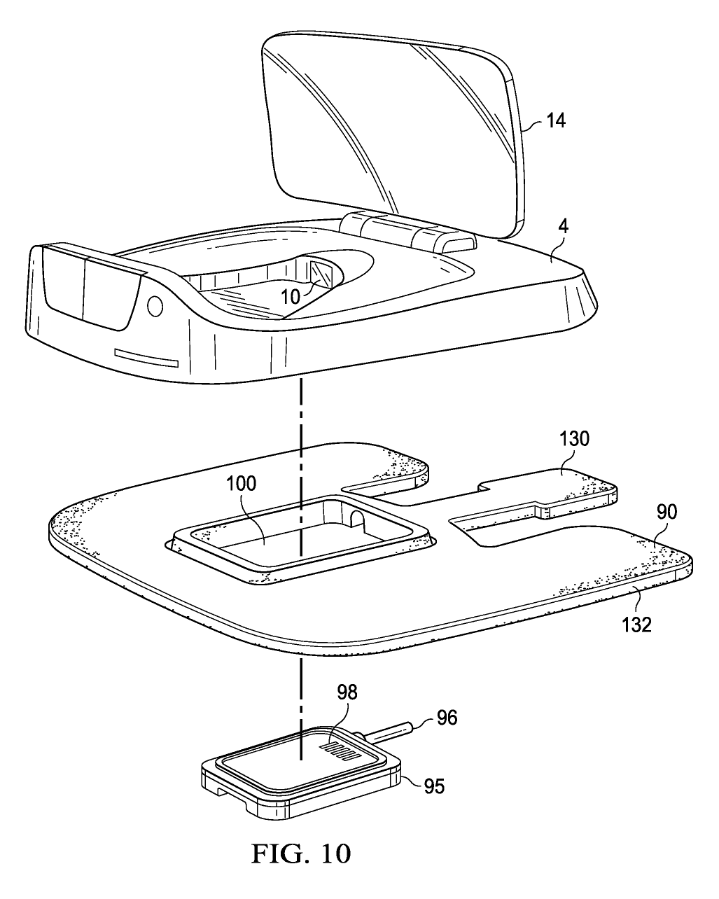

According to these embodiments, HUD device 2 is constructed to be a portable device, in that it can be readily removed from atop the dashboard of one vehicle, and installed in a different vehicle, without requiring significant de-installation and re-installation time and effort. Referring now to FIG. 10, an embodiment of HUD device 2 is shown in an exploded view as having three major physical components: housing 4, “foot” 90, and “puck” 95. As described above, the optical elements of projector engine 10, screen 12, and combiner 14, as well as much of control electronics 6, are realized within or attached to housing 4, along with ancillary components such as cameras 18F, 18R, and others.

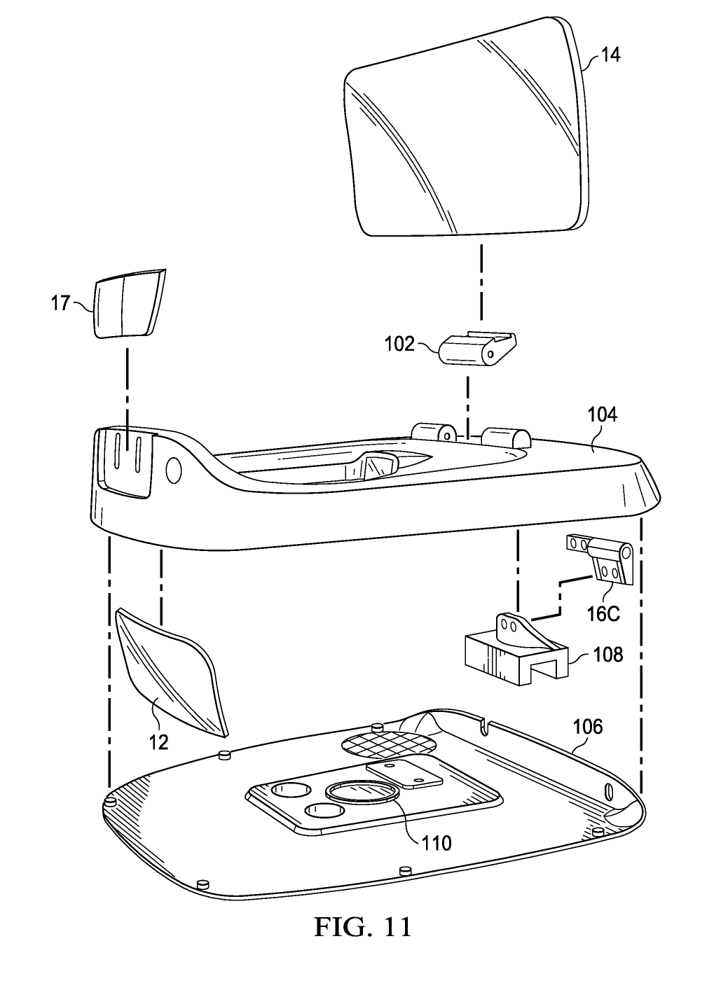

FIG. 11 illustrates an exploded view of the construction of housing 4. Housing 4 includes top shell 104 and belly 106, both of which may be formed of a polycarbonate or other plastic; belly 106 may be formed with an elastomer outer coating if desired. Combiner hinge 102 is an extruded aluminum hinge with separate pin that attaches combiner 14 to shell 104, and which is used to open and close combiner 14 when using and storing HUD device 2, respectively. Combiner hinge 16C, as described above relative to FIGS. 6a and 6b, is a low torque, high stability hinge, such as a Hayana hinge as known in the art, that allows for fine adjustment of combiner 14 while resisting unwanted rotation under vibration. Combiner hinge 16C attaches to belly 106 via hinge bracket 108 in this embodiment. As evident in FIG. 11, screen 12 attaches to belly 206 by way of its hinge 16S (not shown in FIG. 11), so as to extend through an opening in shell 104 when housing 4 is assembled. Light block 17 attaches to shell 104 or directly to screen 12, for blocking light from projector engine 10 (not shown in FIG. 11) from reaching the eyes of driver DRV. In this embodiment, recesses 110 are formed in the center of belly 106 to receive a magnet to mate with puck 95, and to pass through electrical connections between puck 95 and control electronics 6 (not shown in FIG. 11), both of which will be described in detail below.

Referring back to FIG. 10, puck 95 in this embodiment is a molded plastic body that serves two primary functions: provide external electrical connection to HUD device 2 and serve as a mounting platform to which foot 90 can attach. The electrical connection provided via puck 95 may be either or both to a power source (e.g., cigarette lighter in the vehicle) and with a communications facility (e.g., to on-board diagnostic port OBDP of the vehicle, or to a connected device such as smartphone SPH), by way of cable 96. As known in the art, the on-board diagnostics port OBDP typically provides both power and signals carrying vehicle information to HUD device 2. Cable 96 may support appropriate adaptors to plug into various sources of power and data signals in typical vehicles. Connector 98 at the top of puck 95 will connect cable 96 to a corresponding connector of control electronics 6, which will reside above puck 95 when mated to housing 4 (e.g., by way of magnets, as will be described below). The mounting platform function of puck 95 is realized by its outer perimeter, which will fit into a corresponding opening 100 in foot 90 as shown in FIG. 10.

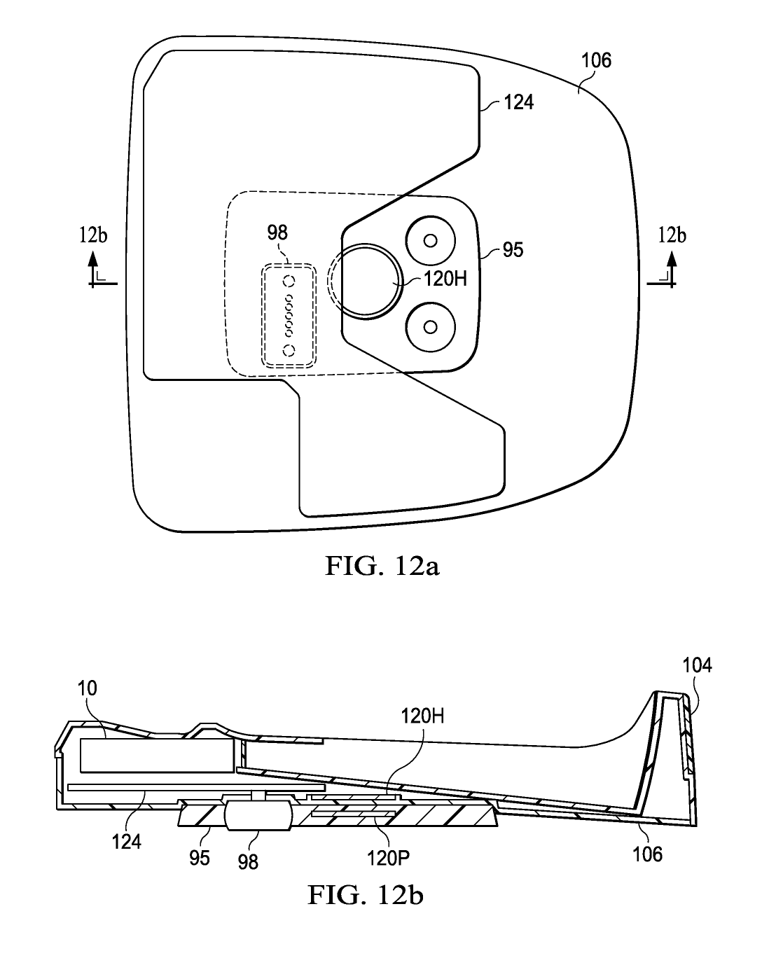

FIGS. 12a and 12b illustrating the mating of puck 95 to housing 4 (in the absence of foot 90, for the sake of clarity). As shown in the top-down cross-section of FIG. 12a and as discussed above relative to FIG. 11, puck 95 occupies a central location of belly 106, with its connector 98 extending upwardly through a corresponding opening in belly 106. Connector 98 mates with terminals (e.g., pogo pins) of circuit board 124 (shown in outline in FIG. 12a and in cross-section in FIG. 12b), on which control electronics 6 are mounted below projector engine 10. Belly 106 includes magnet 120H in a corresponding recess 110 (FIG. 11), that will mate with a corresponding magnet 120P within puck 95 as evident in FIG. 12b, self-aligning and securing housing 4 to puck 95. Because foot 90 is secured to puck 95 as will next be described, housing 4 is thus secured in place on dashboard DSH by this arrangement.

As shown in FIG. 10, foot 90 in this embodiment is a somewhat stiff but bendable element into which puck 95 fits as described above, and which can be bent by the user to conform to various shape dashboards. In this embodiment, once bent to conform to a particular dashboard DSH, foot 90 can remain in place, while housing 4 can be removed. Puck 95 may or may not remain in place under foot 90. In this way, housing 4 and its contents (typically the more expensive component of the system) can be quickly and easily removed, and stored or moved to another vehicle, while leaving foot 90 in place on dashboard DSH.

In this embodiment, foot 90 is constructed to include a “stiffener” core in combination with a bendable and adaptable section. For example, referring to FIG. 10, the stiffener core refers to the interior of foot 90 extending around opening 100 (e.g., the portion of foot 90 that appears somewhat thicker in FIG. 10), while the bendable and adaptable sections of foot 90 comprise wings 132 and kickstand piece 130 extending back from opening 100. This bendable section may be constructed of a core material that is bendable and adaptable, but has “memory” so that it tends to retain its shape after being bent. Examples of materials suitable for the material of the bendable section with “memory” in this regard include various alloys of aluminum; the stiffener core portion forming the ridged part of foot 90 may be formed of a stiffer cast metal. These core portions of the core of foot 90 may then be covered with a softer coating material, such as a plastic or rubber material, with at least the underside of foot 90 having a conformable material at its surface that is also somewhat sticky. This outer conformable material may be inherently sticky, such as a tacky elastomer and some known silicon materials, or may be a composite with a conformable core and a sticky material applied or taped over that conformable core.

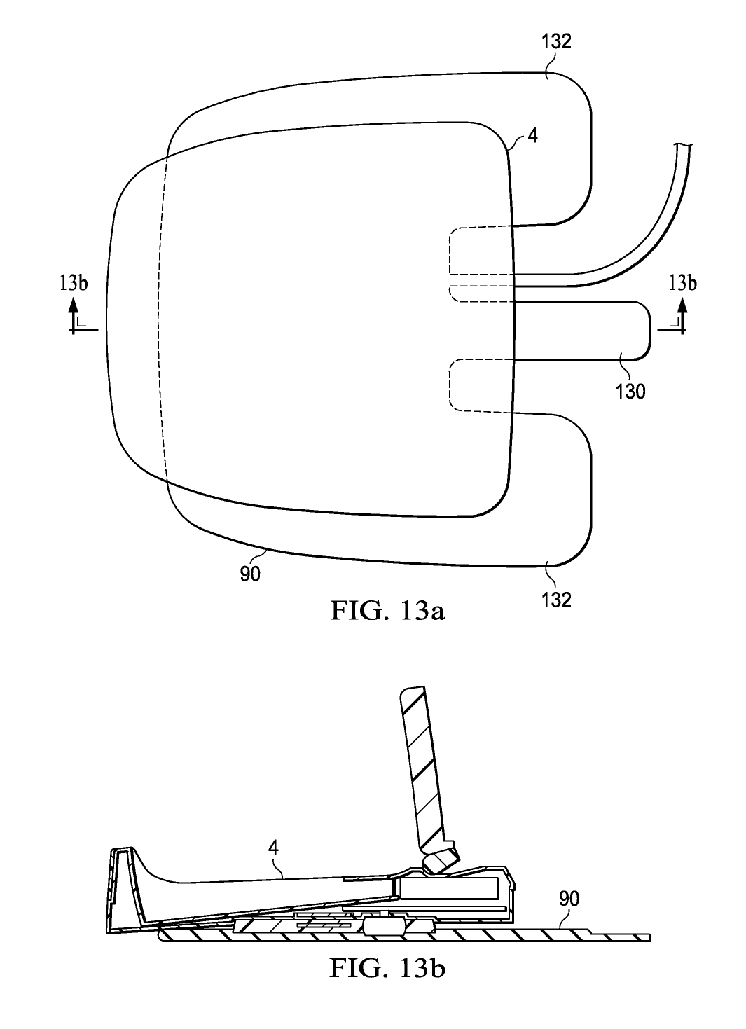

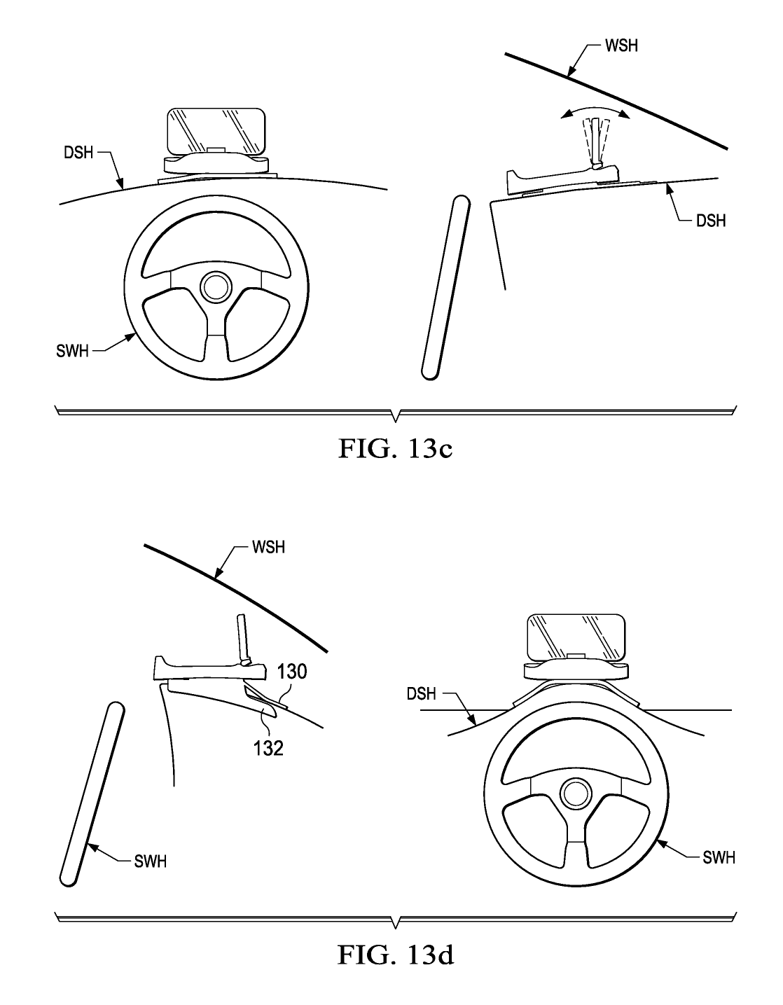

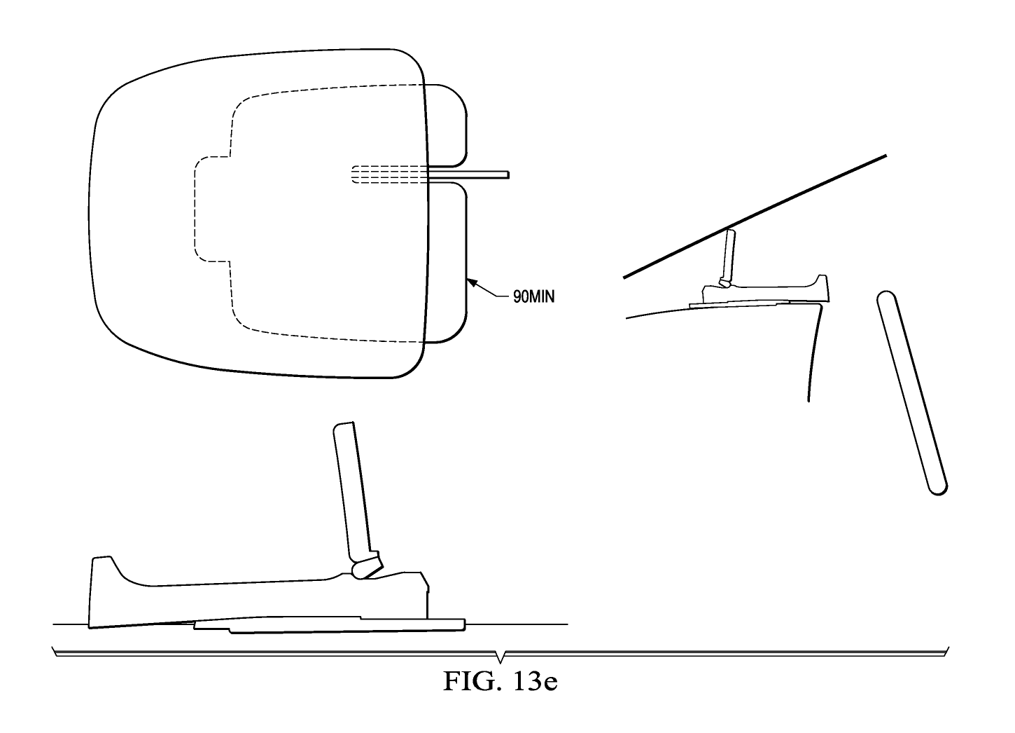

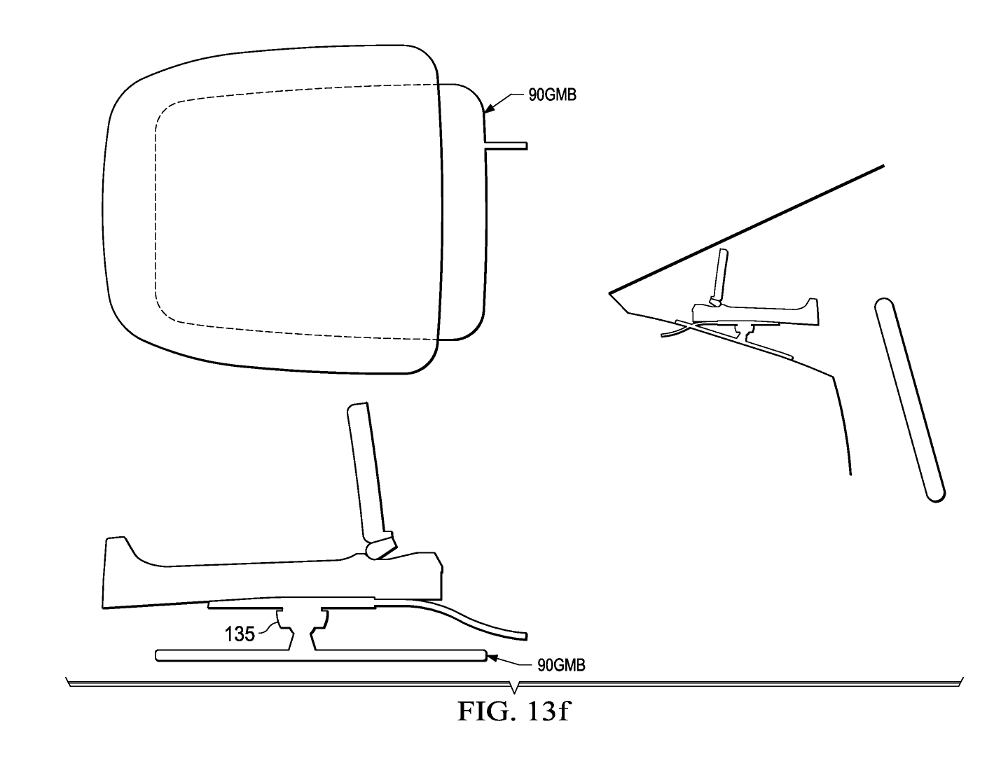

According to this embodiment, multiple versions of foot 90 in various shapes may be provided for HUD device 2, with each version of foot 90 being suitable for fitting a particular type of vehicle dashboard. FIGS. 13a through 13d illustrate the implementation of HUD device 2 with a “standard” version of foot 90 of FIG. 10, as may be suitable for a wide range of car dashboards including slightly sloping dashboards, dashboards with “peaks”, and dashboards that have a moderate to extreme slope away from the driver. FIGS. 13a and 13b illustrate the placement of housing 4 atop foot 90 when mated to puck 95 (not shown) on a flat surface. FIG. 13c illustrates the placement of HUD device 2 on a relatively standard dashboard DSH with windshield WSH having a medium-low profile. As evident from FIG. 13c, in both the front and side elevation views, wings 132 and kickstand 130 conform similarly to the curvature of dashboard DSH; combiner 14 is adjustable as discussed above so as not to hit windshield WSH. FIG. 13d illustrates HUD device 2 also with standard foot 90, but deployed onto dashboard DSH that has a peak above the profile of steering wheel SWH, and which slopes away from driver DRV. In this installation, wings 132 of foot 90 conform to the peak of dashboard DSH, while kickstand 130 is bent so to prop up the rear of housing 4 above the sloping-away surface of dashboard DSH, ensuring that combiner 14 remains in the field of view of driver DRV despite that severe slope.

FIG. 13e illustrates HUD device 2 with a “minimal” version of foot 90MIN. It is contemplated that minimal foot 90MIN is best suited for sports cars with tall dashboards DSH and a tight space between dashboard DSH and windshield WSH. As such, the thickness of foot 90MIN is minimized to the extent possible as shown in the side views of FIG. 13e.

FIG. 13f illustrates HUD device 2 with a gimbaled version of foot 90GMB. It is contemplated that gimbaled foot 90GMB will be best suited for dashboards DSH that are relatively low relative to steering wheel SWH, or that are extremely sloping; vans, some hybrids, and “minis” are examples of cars with this profile. As shown in FIG. 13f, gimbaled foot 90GMB has a relatively flat profile, but with gimbaled ball joint 135 included to allow housing 4 to be tilted at a significantly different angle than the angle that foot 90GMB itself adopts when placed on dashboard DSH.

Each of these embodiments providing a mounting arrangement for HUD device 2 that can be used in a wide range of vehicle types and constructions, specifically over many shapes of dashboards and windshields. In addition, these embodiments allow for housing 4 to be easily removed from foot 90 and puck 95 and readily re-mounted later. As such, HUD device 2 can be realized as a portable device, quickly and easily installable and movable among multiple vehicles, and allowing the user to eliminate the risk of theft when parking a vehicle in a public place.

Also in these embodiments, foot 100 is described above as including a stiffener core, for example of a cast metal, and also a bendable portion (e.g., wings 130 and kickstand piece 132) that itself includes a core of a bendable material with “memory”, such as an aluminum alloy, covered with a plastic or rubber material and having a conformable, somewhat sticky or tacky, material at least on the underside. This construction, particularly with the core portion of the bendable portion of foot 100, will not only enable the secure placement of HUD device 2 on dashboard DSH, but also provides mechanical isolation of projector engine 10, screen 12, and combiner 14 from dashboard DSH, and thus provides stabilization of the image displayed at combiner 14 from vibrations of the vehicle as it travels over the road. Other conventional devices for providing such mechanical isolation may optionally be provided in HUD device 2 as appropriate.

Other approaches for stabilizing the displayed image may alternatively or additionally be implemented in some embodiments. According to one such approach, a “pose sensor”, for example gyroscope 223 (or, alternatively, an inclinometer or other type of pose sensor with a sufficiently high bandwidth, or refresh rate) may be included within HUD device 2, for example within housing 4 attached to the printed circuit board on which control electronics 6 is implemented. Vibrations detected by this pose sensor (e.g. gyroscope 223) may be communicated to system CPU 200, which in turn can control one or more vibration compensation motors that reduce movement of housing 4, or of one or more of the optical structures, such as a lens or mirror in projector engine 10, screen 12, and combiner 14, using conventional active servo control techniques. Alternatively or in addition to these vibration compensation motors, system CPU 200 (or display CPU 210 if implemented) may execute software routines in response to signals from the pose sensor (e.g., gyroscope 223) to “pre-distort” the projected image in response to signals from that pose sensor, so as to effectively stabilize the displayed image at combiner 14.

While one or more embodiments have been described in this specification, it is of course contemplated that modifications of, and alternatives to, these embodiments, such modifications and alternatives capable of obtaining one or more the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A portable heads-up display device comprising:
a housing;
a projector engine disposed in the housing;
a curved screen having an inner surface with high gain, and coupled to the housing so that light from the projector engine is incident on the inner surface; and
a curved semi-transparent combiner having a concave surface, and coupled to the housing so that light reflected from the screen is incident on the concave surface.

2. The device of claim 1, further comprising:
a first hinge for rotatably coupling the screen to the housing; and
a second hinge for rotatably coupling the combiner to the housing.

3. The device of claim 1, wherein the inner surface of the screen is a substantially spherical concave surface.

4. The device of claim 3, wherein the screen is coupled to the housing so as to be tilted upwardly from the direction of incident light from the projector engine;
and wherein the combiner is coupled to the housing so as to be tilted upwardly from the direction of reflected light from the screen.

5. The device of claim 4, wherein the concave surface of the screen is aspherical so as to compensate for distortion;
and wherein the concave surface of the combiner is aspherical so as to compensate for distortion.

6. The device of claim 5, further comprising:
a first hinge for rotatably coupling the screen to the housing; and
a second hinge for rotatably coupling the combiner to the housing.

7. The device of claim 4, further comprising:
control electronics for controlling the projector engine to project images on the inner surface of the screen;
wherein the control electronics controls the projector engine to pre-distort the images as projected to compensate for distortion in the image appearing at the combiner.

8. The device of claim 1, wherein the gain of the inner surface of the screen is at least about 4.0.

9. The device of claim 8, wherein the inner surface of the screen has a surface treatment selected from the group consisting of a roughened surface and a coating, to reflect light in a slightly diffuse manner.

10. The device of claim 1, wherein the inner surface of the screen is constructed in piecewise segments.

11. The device of claim 10, wherein the piecewise segments are arranged as a Fresnel surface.

12. The device of claim 1, wherein the projector engine comprises a plurality of light source elements, each emitting narrow wavelength light of a selected color different from that emitted by others of the plurality of light source elements;
and wherein the inner surface of the screen comprises a dichroic coating to reflect light of selected wavelengths corresponding to the wavelengths of the light emitted by the light source.

13. The device of claim 12, wherein the concave surface of the combiner comprises a dichroic coating to reflect light of selected wavelengths corresponding to the wavelengths of the light emitted by the light source.

14. The device of claim 1, wherein the concave surface of the combiner comprises a dichroic coating to reflect light of selected wavelengths corresponding to the wavelengths of the light emitted by the light source.

15. The device of claim 1, wherein the concave surface of the combiner has a radius of curvature greater than twice the distance between the combiner and the screen.

16. The device of claim 1, further comprising:
a rear-facing sensor generating signals responsive to hand gestures by a user of the device;
control electronics, coupled to the sensor and to the projector engine, for detecting hand gestures by a user from the signals generated by the sensor and for controlling the projector engine to project images responsive to the gestures.

17. The device of claim 16, further comprising:
a microphone;
wherein the control electronics are coupled to the microphone, and control the projector engine to project images also responsive to audio commands received over the microphone.

18. The device of claim 16, wherein the rear-facing sensor comprises a camera.

19. The device of claim 18, wherein the camera is sensitive to infrared light;
and further comprising:
an infrared illuminant;
wherein the screen is disposed within a screen enclosure attached to the housing;
and wherein the camera is attached to the screen enclosure, and the infrared illuminant is attached to the screen enclosure at a location above the camera.

20. The device of claim 16, further comprising:
a second projector for projecting ultraviolet light onto a convex surface of the combiner;
wherein the control electronics are coupled to the second projector, and control the second projector to project images;
and wherein the convex surface of the combiner is sensitive to ultraviolet light, so that images projected by the second projector are visible.

21. The device of claim 16, further comprising:
a forward-facing camera for capturing images;
wherein the control electronics are coupled to the forward-facing camera, and control the projector engine to project images responsive to road position indications in images captured by the forward-facing camera.

22. The device of claim 1, further comprising:
one or more vibration compensation motors disposed in the housing;
a pose sensor disposed in the housing for sensing vibrations; and
control electronics, coupled to the pose sensor, for controlling the one or more vibration compensation motors responsive to signals from the pose sensor.

23. The device of claim 22, wherein the one or more vibration compensation motors are coupled to one or more of the screen and the combiner.

24. The device of claim 1, further comprising:
a pose sensor disposed in the housing for sensing vibrations; and
control electronics, coupled to the pose sensor, for controlling the projector engine to project images on the inner surface of the screen, so that the images are pre-distorted as projected, responsive to signals from the pose sensor, to compensate for vibrations sensed by the pose sensor.

25. The device of claim 1, further comprising:
control electronics comprising:
a transceiver for communicating with an external computing device in the proximity of the heads-up display device;
a display subsystem, coupled to the transceiver, for controlling the projector engine to project images on the inner surface of the screen representing graphics data from applications being executed on the external computing device.

26. A method of producing an image viewable by a driver of a vehicle, comprising:
placing a heads-up display device on a dashboard of a vehicle in front of a driver's seat.
operating a projector engine in the heads-up display device to project an image rearwardly to an inner surface of a curved screen attached to the heads-up display device, the inner surface of the screen having a high gain and facing away from the driver;
reflecting the projected image from the screen to a concave surface of a semi-transparent curved combiner attached to the heads-up display device, the concave surface of the combiner facing the driver.

27. The method of claim 26, wherein the screen is coupled to the housing so as to be tilted upwardly from the direction of incident light from the projector engine;
wherein the combiner is coupled to the housing so as to be tilted upwardly from the direction of reflected light from the screen;
and wherein the step of operating a projector engine comprises pre-distorting the images as projected to compensate for keystone distortion in the image appearing at the combiner.

28. The method of claim 26, wherein the step of operating a projector engine comprises:
modulating light from each of a plurality of light source elements, each light source element emitting narrow wavelength light of a selected color different from that emitted by others of the plurality of light source elements.

29. The method of claim 26, further comprising:
detecting hand gestures made by the driver; and
responsive to a first hand gesture, operating the projector engine to project a first image.

30. The method of claim 29, further comprising:
after the step of operating the projector engine to project the first image, detecting an audio command; and
responsive to the audio command, operating the projector engine to project a second image.

31. The method of claim 29, further comprising:
after the step of operating the projector engine to project the first image, detecting a second hand gesture; and
responsive to the second hand gesture, operating the projector engine to project a third image.

32. The method of claim 29, wherein the step of detecting hand gestures is performed by one or more sensors selected from the group consisting of a camera, an infrared camera, a capacitive sensor, an electromagnetic sensor, and an ultrasonic sensor.

33. The method of claim 29, wherein the step of detecting hand gestures is performed by an infrared camera;
and further comprising:
illuminating the driver with infrared light.

34. The method of claim 26, further comprising:
receiving an external communication at the heads-up display device;
then operating the projector engine to project an image responsive to the external communication;
detecting hand gestures made by the driver; and
then responsive to a third hand gesture, operating the projector engine to project a different image.

35. The method of claim 34, further comprising:
operating a transceiver in the heads-up display device to pair with a communications device in the vicinity of the heads-up display device;
wherein the external communication is received by the communications device and communicated to the transceiver.

36. The method of claim 26, further comprising:
sensing ambient light conditions at the heads-up display device;
wherein the step of operating a projector engine comprises adjusting brightness of the projected light responsive to the sensed ambient light conditions.

37. A portable heads-up display device comprising:
a housing;
a projector engine disposed in the housing;
a screen coupled to the housing so that light from the projector engine is incident on a surface of the screen;
a semi-transparent combiner coupled to the housing to receive light reflected from the screen;
at least one rear-facing sensor attached to the housing, for generating signals responsive to hand gestures by a user of the device; and
control electronics, coupled to the sensor and to the projector engine, for detecting hand gestures by a user from the signals generated by the sensor and for controlling the projector engine to project images responsive to the gestures.

38. The device of claim 37, further comprising:
a microphone attached to the housing;
wherein the control electronics are also coupled to the microphone, and control the projector engine to project images also responsive to audio commands received over the microphone.

39. The device of claim 37, wherein the at least one rear-facing sensor is selected from the group consisting of a camera, an infrared camera, a capacitive sensor, an electromagnetic sensor, and an ultrasonic sensor.

40. The device of claim 37, wherein the at least one rear-facing sensor is sensitive to infrared light;
and further comprising:
an infrared illuminant.

41. The device of claim 37, wherein the screen is disposed within a screen enclosure attached to the housing;
and wherein the camera is attached to the screen enclosure, and the infrared illuminant is attached to the screen enclosure at a location above the camera.

42. A heads-up display device, comprising:
a housing body;
a projector engine disposed in the housing body;
a display screen attached to the housing to receive projected light from the projector engine;
a first magnet disposed near the underside of the housing body;
a puck element including a second magnet; and
a foot element, comprising:
a stiffener portion disposed around an opening for receiving the puck element; and
a bendable portion extending from the stiffener portion and away from the opening;
wherein the bendable portion of the foot element is conformable to a curved surface with the puck element within the opening in the stiffener portion and the first and second magnets mated to one another.

43. The device of claim 42, wherein the bendable portion of the foot element comprises:
a bendable core material capable of retaining its shape after being bent;
a conformable material on the underside of the foot element.

44. The device of claim 43, wherein the conformable material has a sticky surface.

45. The device of claim 43, wherein the bendable core material comprises an aluminum alloy.

46. The device of claim 43, wherein the bendable portion of the foot element extends laterally beyond the housing body with the puck element within the opening in the stiffener portion and the first and second magnets mated to one another.

47. The device of claim 43, wherein the foot element further comprises:
a gimbal ball joint, disposed beneath the housing body with the puck element within the opening in the stiffener portion and the first and second magnets mated to one another, to permit tilting of the housing body relative to the foot element.

48. The device of claim 43, wherein the bendable portion of the foot element comprises:
first and second wings extending laterally from first and second sides of the foot element; and
a kickstand tail piece extending from a third side of the foot element.

49. The device of claim 42, wherein the puck element comprises:
a body including the second magnet, and having a shape corresponding to the opening in the stiffener portion of the foot element;
an electrical connector at a top surface of the body; and
a cable electrically coupled to the electrical connector and extending from the puck element to a plug.
